(19) United States
(12) Patent Application Publication
(10) Pub. No.: US 2025/0299198 A1
(43) Pub. Date: Sep. 25, 2025

(54) CUSTOMER SERVICE TOOL.

(71) Applicant: Target Brands, Inc., Minneapolis, MN (US)

(72) Inventors: Julie Marchant, Minneapolis, MN (US); Amar Sahu, Bengaluru (IN); Amit Bhattacharjee, Bengaluru (IN); Aftab Faisal, Bengaluru (IN); Shamayita Debnath, Bengaluru (IN); Tarun Kumar, Bengaluru (IN); Rakesh Sankappanavar, Bengaluru (IN)

(21) Appl. No.: 18/612,427

(22) Filed: Mar. 21, 2024

(51) Int. Cl. G06Q 30/015; G06Q 30/0601

(52) U.S. Cl. CPC G06Q 30/015; G06Q 30/0633; G06Q 30/0643

(57) ABSTRACT

The present disclosure is directed to resolving customer service issues associated with online shopping. When a customer requiring assistance regarding price matching the price of an item in the customer's active shopping cart or a previously ordered item to a competitor price, the customer contacts the customer service agent. The customer service agent, using the disclosed customer service assistance system, may use one or more administrative options otherwise unavailable to the customer to execute a modification in the price of the item or issue a concession for the item. The customer service assistance system may automatically collect and display competitor pricing, stock availability, selling entity information to assist the customer service agent in resolving the customer's price matching request quickly and efficiently.

### BACKGROUND

In the past, customers predominantly shopped in person at retail stores for items. With the advent of the World Wide Web, more and more customers use the internet to shop online because of its convenience. Typically, the process of online shopping involves many operations including: searching and locating items on a retailer's website, adding the items to a virtual shopping cart and following a virtual checkout process including providing payment and shipment information.

In some instances, customers may encounter issues with the process of online shopping and may require assistance from a customer service agent. Customers may communicate with the customer service agent through the telephone or online messaging. One typical issue with online shopping that customers routinely need assistance from customer service agents includes matching the price of an item to a competitor price.

### SUMMARY

Generally, the present disclosure relates to a system and method for providing efficient customer service assistance to customers shopping online.

In a first aspect, a system for assisting customers who request customer service help is disclosed. The system includes: a computing system comprising: a processor; a memory communicatively connected to the processor, the memory storing program instructions including a customer service tool, the program instructions being executable by the processor to cause the computing system to: receive credential information of a customer service agent associated with a retailer; receive identification data associated with a customer; responsive to receiving the identification data and validating the credential information of the customer service agent, generate an agent user interface presentable at a remote customer service agent device, the agent user interface including: a first administrative option selectable by the customer service agent to modify a price of a pre-purchase item that is included within an active shopping cart of the customer before the customer completes purchasing the pre-purchase item from the retailer, wherein upon selection of the first administrative option to modify the price of the pre-purchase item, the agent user interface displays: a first graphical representation of the active shopping cart of the customer, the active shopping cart being associated with the identification data, and the first graphical representation having an appearance corresponding to a first customer view of the active shopping cart within a customer user interface; and a second administrative option selectable by the customer service agent to issue a concession for an order item after the customer completes purchasing the order item from the retailer, wherein upon selection of the second administrative option to issue the concession for the order item, the agent user interface displays: a second graphical representation of a customer order information, the customer order information being associated with the identification data, and the second graphical representation having an appearance corresponding to the second customer view of the customer order information within the customer user interface.

In a second aspect, a method for assisting customers who request customer service help is disclosed. The method includes: prompting a customer service agent to input credentials, wherein the credentials correspond to an identity of the customer service agent; in response to a positive verification of the credentials, prompting the customer service agent to enter identification data associated with a customer; receiving the identification data associated with the customer from the customer service agent; in response to receiving the identification data, providing an agent user interface to the customer service agent, the agent user interface including: a first administrative option selectable by the customer service agent to modify a price of a pre-purchase item that is included within an active shopping cart of the customer before the customer completes purchasing the pre-purchase item from the retailer, wherein upon selection of the first administrative option to modify the price of the pre-purchase item, the agent user interface displays: a first graphical representation of the active shopping cart of the customer, the active shopping cart being associated with the identification data, and the first graphical representation having an appearance corresponding to a first customer view of the active shopping cart within a customer user interface.

In a third aspect, a system for assisting customers who request customer service help is disclosed. The system includes: a computing system comprising: a processor; a memory communicatively connected to the processor, the memory storing program instructions including a customer service tool, the program instructions being executable by the processor to cause the computing system to: receive a request, from a customer, directed to a customer service agent representing a retailer, to match a price of an item from the retailer to a competitor price; receive identification data associated with the customer from the customer service agent; in response to receiving the identification data, provide an agent user interface to the customer service agent, the agent user interface including: a graphical representation of a customer user interface as viewed by the customer on a customer device, the graphical representation including a graphical view of an active shopping cart and the customer order information associated with an account of the customer; a first administrative option selectable by the customer service agent for when the item is a pre-purchase item that is included within the active shopping cart of the customer before the customer completes purchasing the pre-purchase item from the retailer, and a second administrative option selectable by the customer service agent for when the item is an order item that is included within the customer order information of the customer after the customer completes purchasing the order item from the retailer; and wherein upon selection of the first administrative option, execute instructions to modify the price of the item, a modified price for the item having a value up to the competitor price, including displaying the modified price for the item on the active shopping cart within the customer user interface as viewed by the customer on the customer device; and wherein upon selection of the second administrative option, execute instructions to issue a concession for the item, the concession having a value that is up to the difference between the price of the item and the competitor price, including displaying the concession amount for the item on the customer order information within the customer user interface as viewed by the customer on the customer device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example of the customer service assistance system.

FIG. 1 illustrates an example of the customer service assistance system.

FIG. 2 illustrates another example of the customer service assistance system from FIG. 1.

FIG. 3 illustrates an example computing system that stores instructions associated with the customer service assistance system from FIG. 1.

FIG. 4 illustrates an example customer account information data store of the customer service assistance system from FIG. 2.

FIG. 5 illustrates an example shopping cart information data store of the customer service assistance system from FIG. 2.

FIG. 6 illustrates and example order information data store of the customer service assistance system from FIG. 2.

FIG. 7 illustrates and example pricing information data store of the customer service assistance system from FIG. 2.

FIG. 8 illustrates a flowchart of an example execution of instructions at the customer service assistance computing system from FIG. 2.

FIG. 9 illustrates an example agent user interface and an example customer user interface as generated by the customer service assistance computing system from FIG. 2.

FIG. 10 illustrates a flowchart of an example set of operations executed by a customer service agent in assisting a customer.

FIG. 11 illustrates an example customer user interface as generated by the customer service assistance system of FIG. 2.

FIG. 12 illustrates an example price modification agent user interface as generated by the customer service assistance system of FIG. 2.

FIG. 13 illustrates an example “competitor prices” panel of the price modification agent user interface.

FIG. 14 illustrates an example “modify price” panel of the price modification agent user interface.

FIG. 15 illustrates another example customer user interface as generated by the customer service assistance of FIG. 2.

FIG. 16 illustrates an embodiment of an issue concession agent user interface as generated by the customer service assistance system of FIG. 2.

FIG. 17 illustrates an embodiment of the final “issue a concession” panel of the issue concession agent user interface from FIG. 16.

FIG. 18 illustrates an example “guest view” of the customer account, as displayed on the agent user interface from FIG. 9.

FIG. 19 illustrates the concurrent display of multiple sessions within the same agent user interface from FIG. 9.

FIG. 20 illustrates a flowchart showing an example set of operations executed by the customer service assistance system in price matching an item to a competitor price.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general, for online retailers, 5% to 15% of customer contacts of customer service agents is related to price match requests. On average, customer service agents spend 450 seconds per contact to validate and honor these price match requests. Typically, the customer service agents use a manual process to verify the request and calculate the modified price or concession amount. These manual efforts can be improved by at least partially automating the price matching process to improve efficiency of price matching processes, improve accuracy and consistency of price matching decisions, and reduce guest wait times.

In general, the subject matter of this disclosure relates to a customer service tool that automatically provides competitor prices for products on a customer service agent user interface in order for the customer service agent to efficiently facilitate a price modification or concession related to products in a customer's shopping cart pre-checkout or products that have already been purchased by the customer. The customer service tool disclosed herein operates by permitting the customer service agent to access the customer's shopping cart and account information, and editing the price information associated with the products in the customer's cart pre-checkout or price information associated with products that the customer has already purchased in ways that the customer may not be permitted. The customer service tool disclosed herein generates a user interface that includes one or more options that enable the customer service agent to quickly access competitor price information and determine refund amounts. This enables the agents to resolve the customer's issues quickly and efficiently.

The architecture, implementation and additional functionality associated with the disclosed customer service tool are described further in U.S. Pat. No. 11,042,918, the disclosure of which is incorporated herein in full.

Upon selection of a product from the customer's pre-checkout shopping cart or the post-purchase order information, the disclosed customer service tool automatically generates a customer service agent user interface that includes a list of competitors that sell the same product, the prices that the competitors charge for the product, whether the competitor has the product in stock, and whether the product qualifies for price matching, among other details. The customer service tool may also provide a selectable uniform resource locator (URL) link that when selected by the customer service agent, redirects the customer service agent to the competitor's webpage selling the product online. The customer service agent may thus verify the information related to the competitor price before determining whether to authorize a price modification or concession and determining the price modification and/or concession amount. The customer service agent user interface may also include an option to review any previous concessions that have been granted for the product, an option to cancel the concession and an option to revert back to the original price.

After a price is modified for a pre-checkout item that is still in the customer's shopping cart, the price change may be updated on all applicable subtotals and appears on the customer's user interface. The customer service agent may also include a concession in addition to or in place of a price modification for a pre-checkout item in an active shopping cart. With concessions that are applied towards pre-purchase items in the customer's shopping cart, the concessions are issued at the time of the sale itself and are not issued as refunds after the customer completes the purchase. This reduces average handle times, failed concessions, repeated contacts between customers and customer service agents, thus increasing efficiency, confidence and satisfaction of the customers. For concessions that are issued for post-purchase items, the concession may be applied as a reduction in invoice amount if the purchase has not been invoiced to the customer's credit/debit card and as a refund if the purchase has already been invoiced to the customer's credit/debit card.

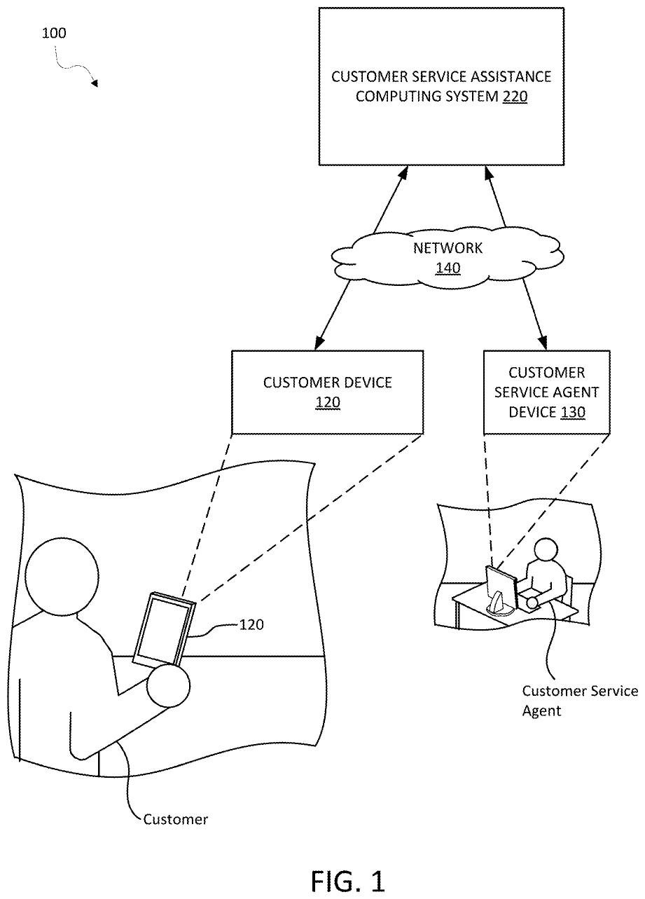

FIG. 1 illustrates an example customer service assistance system 100 including a customer service assistance computing system 220, a customer device 120 and a customer service agent device 130, both communicatively connected to the customer service assistance computing system 220 through a network 140. A customer operates the customer device 120 and a customer service agent operates the customer service agent device 130.

In an example, the customer device 120 and customer service agent device 130 can take a variety of forms. For example, the customer device 120 may be any type of mobile or desktop computing system and may present to a user his/her account, shopping cart, or order information in a web browser window or within a mobile application. The customer service agent device 130 may similarly be a variety of types of devices; in some examples, the customer service agent device 130 may be a trusted computing terminal dedicated to accessing customer order data (e.g., a WYSE or Citrix-based terminal). In an alternative example, the customer service agent device 130 may be any desktop or mobile device that is not dedicated to accessing customer order data; in such examples, the device 130 may be limited in terms of the types of customer data that may be accessed (e.g., non-sensitive financial data such as non-PCI data).

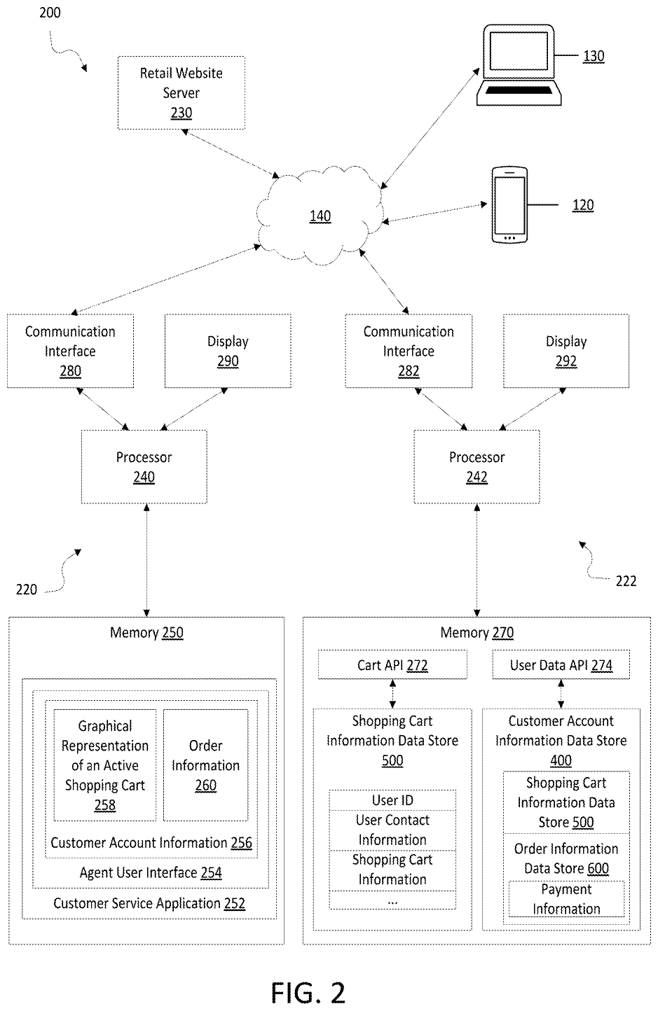

FIG. 2 illustrates another example of a customer service assistance system 200. The system 200 represents one possible version of the customer service assistance system 100 of FIG. 1, including details regarding tools used to assist a customer service agent in accessing customer account, order, or cart data for purposes of facilitating customer assistance.

In the example shown, the customer service assistance system 200 includes a customer service assistance computing system 220 and a customer data store computing system 222, both communicatively connected to a retail website server 230, a customer device 120 and a customer service agent device 130 via network 140 (e.g., the Internet). The retail web server 230 presents items to a customer device 120 and a customer service agent device 130, which display such items to the customer and the customer service agent via either a browser or application. A user may select one or more items for purchase, and those items are then associated with the user account of that user.

The customer service assistance computing device 220 includes a processor 240 communicatively connected to a memory 250 via a data bus. The customer data store computing system 222 also includes a processor 242 communicatively connected to a memory 270 via a data bus. It is noted that, in some examples, the customer data store computing system 222 may be located remotely from the customer service assistance computing system 220, so long as it is accessible to the customer service assistance computing system 220.

The processor 240 and 242, respectively, can be any of a variety of types of programmable circuits capable of executing computer-readable instruction to perform various tasks, such as mathematical and communication tasks. The memory 250 and 270, respectively, can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Computer storage media generally includes at least one or more tangible media or devices. Computer storage media can, in some examples, include entirely non-transitory components.

The customer service assistance computing device 220 and customer data store computing system 222 include communication interfaces 280 and 282, respectively configured to receive and transmit data. In one example, the customer service assistance computing system 220 may access data in an external data store, such as through the customer data store computing system 222. Display 290 is connected to processor 240 and can be used to view any underlying data that exists within memory 250 associated with the customer assistance computing system 220. Display 292 is connected to processor 242 and can be used to view any underlying data that exists within memory 270 associated with the customer data store computing system 222.

In the example shown, the memory 270 associated with the customer data store computing system 222 stores, and exposes, a cart API 272 and a user data API 274. In general, an API, or Application Programming Interface is a set of functions or procedures that enables a program or application to gain access to underlying data. In some examples, memory 270 also includes the shopping cart information data store 500 and a customer account information data store 400. In other examples, the shopping cart information data store 500 and the customer account information data store 400 may not be located within the same computing system but rather in different computing systems that are connected remotely. The memory 270 also includes instructions for a pricing engine 276.

The cart API 272 controls access to the shopping cart information data store 500, for example, for access by the customer service assistance computing device 220 or customer device 120. The user data API 274 controls access to the customer account information data store 400, for example, for access by the customer service assistance computing device 220 or customer device 120. Accordingly, the same data may be accessed by both a customer and a customer service representative.

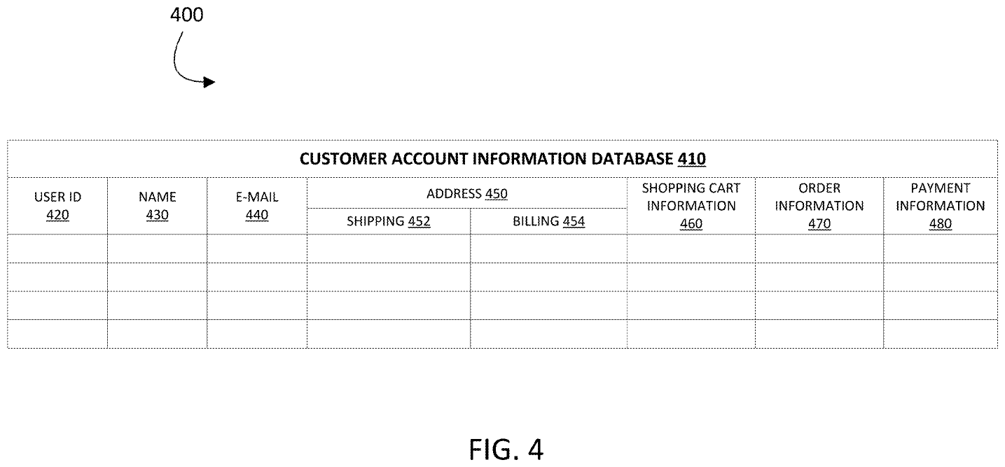

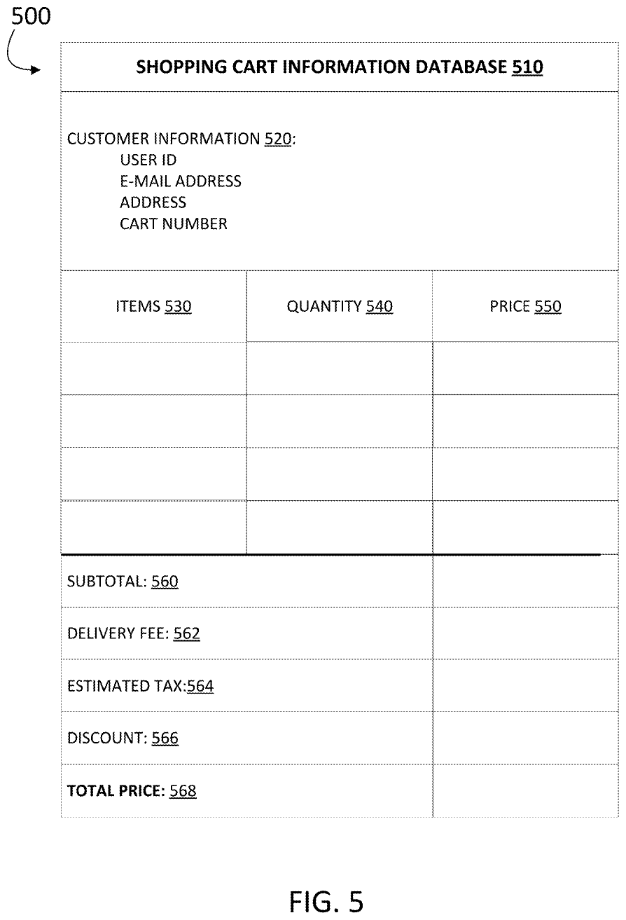

In various examples, the customer account information data store 400 includes data regarding the customer's account and is described in further detail as related to FIG. 4. In addition to other customer account information, the customer account information data store 400 also includes a shopping cart information data store 500 and order information data store 600. The order information data store 600 can include PCI information such as credit card or debit card information. In various examples, the shopping cart information data store 500 includes data regarding the customer's shopping cart items and is described in further detail as related to FIG. 5.

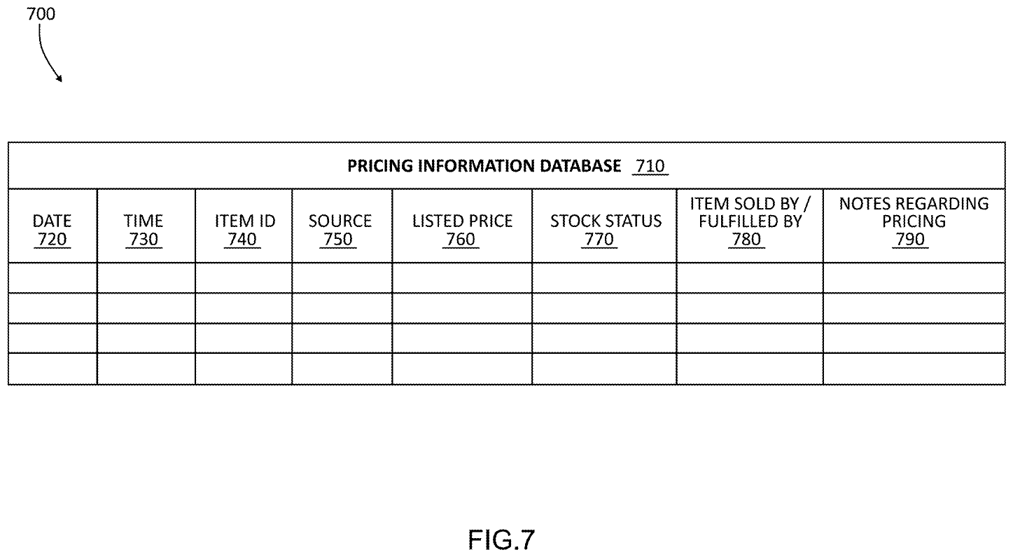

The pricing engine 276 interfaces with various internal pricing data stores as well as accesses competitor pricing and stock information periodically to scrape pricing data and store it in a pricing information data store 278. For example, the pricing engine 276 may scrape pricing and discount information across various data stores internal to the retailer. In addition, the pricing engine 276 may pull pricing and stock information as published by competitor webpages. For example, for each product stocked by the retailer, the pricing engine 276 may access a known list of competitor webpages that also offer the same product for sale and identify the price, any discounts offered, whether the product is currently in stock, etc. The scraping of the pricing information internally and externally across competitor webpages may occur daily, bi weekly, weekly or any other regular intervals. The scraped pricing information may be stored in a pricing information data store 278. An example pricing data store is described in further detail as related to FIG. 7.

In the example shown, the memory 250 associated with the customer service assistance computing system 220 stores a customer service application 252. In various examples, the customer service application 252 includes an agent user interface 254. In general, the customer service application 252 receives customer identification data entered by the customer service agent. Responsive to receiving the customer identification data, the customer service application 252 generates an agent user interface 254 presentable at a remote customer service agent device 130. The agent user interface 254 displays customer account information 256 that is associated with the customer identification data entered by the customer service agent. The customer account information 256 includes a graphical representation of an active shopping cart of the customer 258 and order information 260.

In various examples, the customer account information 256 is generated based on data derived from the customer account information data store 400, which can be accessed through the user data API 274. The graphical representation of an active shopping cart 258, which is displayed on the agent user interface 254 as part of the customer account information 256, is generated based on data derived from the shopping cart information data store 500, which can be accessed through the cart API 272. The order information 260, which is displayed on the agent user interface 254 as part of the customer account information 256, is generated based on data derived from the order information data store 600, which can also be accessed through the user data API 274.

It is noted that in some example examples, the user data API 274 may provide access control to certain types of user data. Any sensitive or otherwise private data related to a customer account is only accessible by customer service agents with the proper access rights. For example, only a customer service agent supervisor may have permission to access or view a customer's credit card information that is included in the order information data store 600. Or, only a customer service agent using a trusted terminal (e.g., a computing device having a higher level of security, or being positioned within an enterprise, or otherwise having stronger access controls to ensure security of customer data) may access such sensitive customer data, while a comparatively lower-security computing terminal (e.g., a remote access terminal or other type of customer service agent computing system) may still be provided with the ability to view a customer's shopping cart and selected customer account or order information, but certain types of data may be excluded from that view that may otherwise be included (e.g., credit card or other data, including, for example, PCI data).

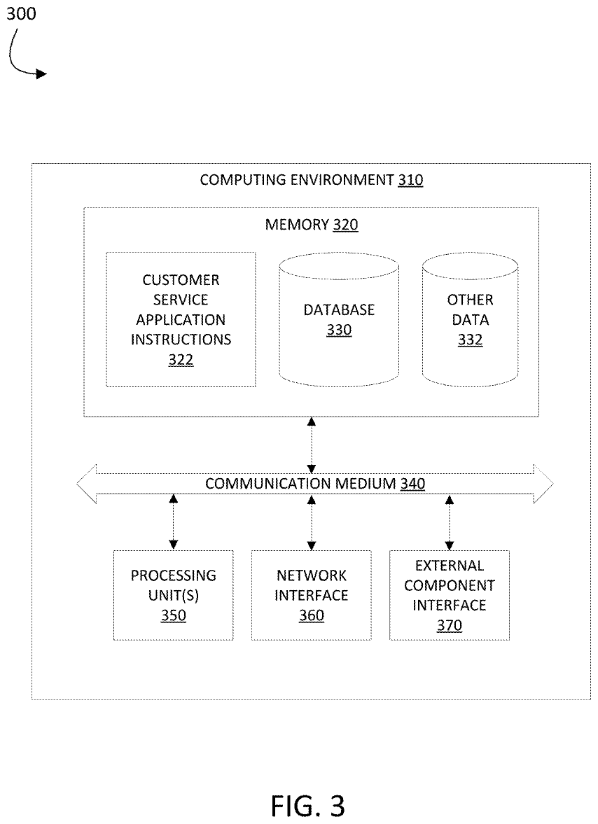

FIG. 3 illustrates an example computing system 300 with which disclosed systems and methods can be used. In an example, the computing system 300 can include a computing environment 310. The computing environment 310 can be a physical computing environment, a virtualized computing environment, or a combination thereof, and useable as any of the computing systems described above in connection with FIG. 1. The computing environment 310 can include memory 320, a communication medium 340, one or more processing units 350, a network interface 360, and an external component interface 370.

The memory 320 can include a computer readable storage medium. The computer storage medium can be a device or article of manufacture that stores data and/or computer-executable instructions. The memory 320 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 320 can store various types of data and software. For example, as illustrated, the memory 320 includes instructions 322 for implementing one or more aspects of the customer service assistance system described herein, for example, the customer service application 252, as well as database 330 and other data 332. In some examples, the memory 320 can include customer account information data store 400, the shopping cart information data store 500 and/or order information data store 600, or instructions for accessing such data.

The communication medium 340 can facilitate communication among the components of the computing environment 310. In an example, the communication medium 340 can facilitate communication among the memory 320, the one or more processing units 350, the network interface 360, and the external component interface 370. The communications medium 340 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 350 can include physical or virtual units that selectively execute software instructions. In an example, the one or more processing units 350 can be physical products comprising one or more integrated circuits. The one or more processing units 350 can be implemented as one or more processing cores. In another example, one or more processing units 350 are implemented as one or more separate microprocessors. In yet another example, the one or more processing units 350 can include an application-specific integrated circuit (ASIC) that provides specific functionality. In yet another example, the one or more processing units 350 provide specific functionality by using an ASIC and by executing computer-executable instructions.

The network interface 360 enables the computing environment 310 to send and receive data from a communication network (e.g., network 16). The network interface 360 can be implemented as an Ethernet interface, a token-ring network interface, a fiber optic network interface, a wireless network interface (e.g., WI-FI), or another type of network interface.

The external component interface 370 enables the computing environment 310 to communicate with external devices. For example, the external component interface 370 can be a USB interface, Thunderbolt interface, a Lightning interface, a serial port interface, a parallel port interface, a PS/2 interface, and/or another type of interface that enables the computing environment 310 to communicate with external devices. In various examples, the external component interface 370 enables the computing environment 310 to communicate with various external components, such as external storage devices, input devices, speakers, modems, media player docks, other computing devices, scanners, digital cameras, and fingerprint readers.

Although illustrated as being components of a single computing environment 310, the components of the computing environment 310 can be spread across multiple computing environments 310. For example, one or more of instructions or data stored on the memory 320 may be stored partially or entirely in a separate computing environment 310 that is accessed over a network.

FIG. 4 illustrates an example customer account information data store 400. One example of the customer account information data store 400 includes a customer account information database 410. The customer account information data store 400 may also include other storage methods. The customer account information database 410 stores a plurality of customer entries. Each customer entry is associated with a particular customer account and describes different aspects of that particular customer account. A non-limiting list of aspects for each customer entry includes: user identification information or user ID 420, name 430, email address 440, address 450, shopping cart information 460, order information 470 and payment information 480. The name 430 may include both the first and last names of the customer. The address 450 includes both the customer's shipping address 452 and the customer's billing address 454. The shopping cart information 460 may link to the shopping cart information data store 500 and may retrieve data as necessary. The order information 470 may link to the order information data store 600 and may retrieve data as necessary. The payment information 480 may include one or more of the customer's credit card, debit card or other method of payment information. Other aspects of a customer account may also be included for each customer entry under the customer account information database 410.

FIG. 5 illustrates an example shopping cart information data store 500. The shopping cart information data store 500 stores data associated with a customer's virtual shopping cart. One example of the shopping cart information data store 500 includes a shopping cart information database 510. The shopping cart information data store 500 may also include other storage methods. The shopping cart information database 510 stores a plurality of item entries. Each item entry is associated with a particular shopping item and describes different aspects of that particular shopping item. A non-limiting list of aspects for each shopping item includes: customer information 520, items 530, quantity 540, price 550, subtotal 560, delivery fee 562, estimated tax 564, discount 566, and total price 568. The customer information 520 includes identification information regarding the customer account associated with the shopping cart. This customer information 520 may include: user ID, email address, address and cart number among other customer account related information. The items 530 list each shopping item by name or item ID number. The quantity 540 lists the number of each shopping item the customer wishes to purchase. The price 550 lists the price per item of item 530 multiplied by the quantity 540 of items. The subtotal 560 is sum of the prices 550 from all the item entries listed under the shopping cart information database 510. The delivery fee 562 is an additional fee for delivery of item to customer's address and is based on the customer's shipping address 452. The estimated tax 564 includes an estimate of the total tax amount charged for the plurality of items stored in the shopping cart information data store 500. The discount 566 includes the total amount in reductions in price for the plurality of items in the shopping cart information data store 500. The discount amount may depend on the underlying coupon, concession, clearance, promotion, etc. The total price 568 is the sum of the subtotal, delivery fee, estimated tax reduced by the discount and represents the total price the customer needs to pay to own and receive the shopping items in the shopping cart. Other aspects of a customer shopping cart may also be included for each shopping item entry under the shopping cart information database 510.

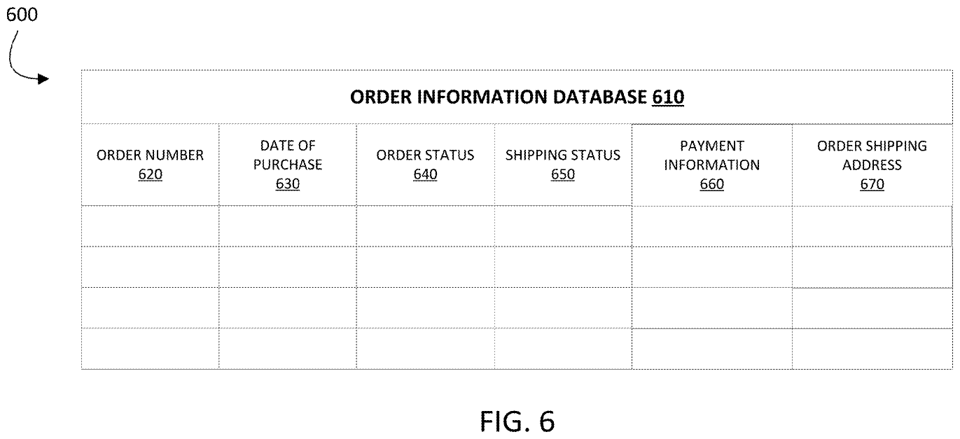

FIG. 6 illustrates an example order information data store 600. The order information data store 600 stores data associated with a customer's historical orders. One example of the order information data store 600 includes order information database 610. The order information data store 600 may also include other storage methods. The order information database 610 stores a plurality of order entries. Each order entry is associated with a particular order placed in the past by the customer and describes different aspects of that particular order. A non-limiting list of aspects for each order includes: order number 620, date of purchase 630, order status 640, shipping status 650, payment information 660 and order shipping address 670. The order number 620 lists the identification number associated with the particular order. The date of purchase 630 lists the date on which the order was completed. The order status 640 lists the status of the order including, but not limited to: order completed, cancelled and returned. The shipping status 650 lists the shipping status as the order including, but not limited to: awaiting shipment, shipped, delayed, and delivered. The shipping status 650 may also include shipment tracking information including carrier used to ship the order, current location, and estimated date of delivery. The payment information 660 includes details regarding the form of payment used to complete the order purchase. The payment information 660 may include credit card information, debit card information, third-party payment information, gift card information, etc. The order shipping address 670 lists the address to which the order is shipped.

FIG. 7 illustrates an example pricing information data store 700. The pricing information datastore 700 stores data associated with the retailer's own pricing information, and competitor pricing information. One example of the pricing information data store 700 includes a pricing information database 710. The pricing information data store 700 may also include other storage methods. The pricing information database 710 stores a plurality of pricing entries. Each pricing entry is associated with the pricing of a particular product at a particular date and time and includes different aspects of the product pricing. Each product that is carried by the retail store may include at least one entry within the pricing information database 710. The pricing information database 710 may include a plurality of pricing entries for the same product, one for each source of the price. The retailer may maintain a different pricing information data store 700 for different retail locations or for different zip codes.

A non-limiting list of aspects for each pricing information entry includes: date 710, time 720, item identifier 730, source 750, listed price 760, stock status 770, items sold by/fulfilled by 780 and notes regarding pricing 790. The date 720 and time 730 lists the date and time at which the pricing information is scraped or obtained from retailer's own listing of the product or a competitor's listing of the product. The item identifier 740 lists identifier, typically an alphanumeric code, that is used to identify the product or item by the retailer. The source 750 lists the source of the pricing information. In some examples, the source may be a competitor's webpage with a listing of the price. In other examples, the source may be the retailer's own webpage with a listing of the price. The source 750 may also include a URL link to the source with the listing of the price. Other types of sources are also possible, including a print listing of the price of the product that has been manually entered by an employee of the retailer. The listed price 760 lists the current price as offered by the source 750 at the date and time as listed within the entry for the date 720 and time 730 aspects. The stock status 770 lists the availability of the product for sale at the source 750 at the date and time as listed within the entry for the date 720 and time 730 aspects. In some examples, the stock status 770 may list the status as currently available. In other examples, the stock status 770 may list the status as running low or out of stock. Other types of stock status 770 entries are also possible. The item sold by/fulfilled by 780 entry lists the name of the retailer that sells the item and the name of the retailer that fulfils the item. The notes regarding pricing 790 entry within the pricing information database 710 lists any additional terms or conditions or other notes associated with any discounts or concessions applied to the listed price. For example, the notes regarding pricing 790 may include entries that state that the listed price only applies if two items are purchased together, the listed price would only apply when the user presented a printed coupon, the listed price would only apply when the customer presented a store credit card, etc.

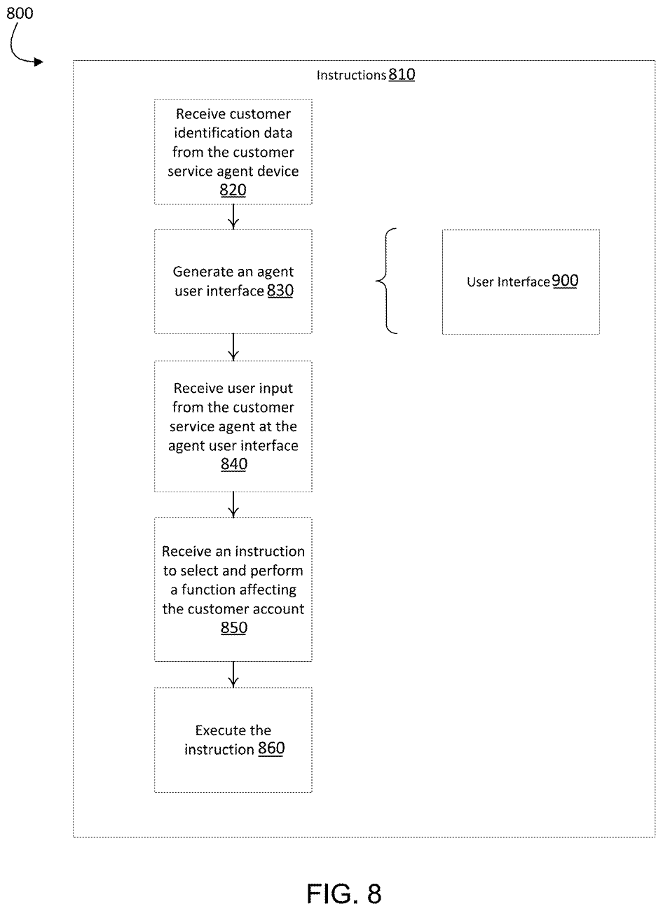

FIG. 8 illustrates a flowchart of an example method 800 that may be performed by a customer service assistance computing system. As shown in FIG. 2, the customer service assistance computing system 220 comprises a processor 240, and a memory 250 communicatively connected to the processor, the memory 250 storing program instructions 810 executable by the processor 240. The flowchart depicted in FIG. 7 shows an example execution flow of the program instructions 810 at the customer service assistance computing system 220 and may include the following operations: receive customer identification data from the customer service agent device 820; generate an agent user interface 830; receive user input from the customer service agent at the agent user interface 840; receive an instruction to select and perform a function affecting the customer account 850; and execute the instruction 860.

Initially, the customer service agent may log in to the customer service tool by providing his/her credentials such that the agent user interface 254 is customized based on the identity of the customer service agent. One example of the type of credentials that can be entered into the customer service tool includes the customer service agent's user ID and password. Next, the customer service agent enters the customer identification data associated with a customer on the customer service agent device 130 and the customer service assistance computing system receives the entered customer identification data associated with the customer 820. The customer identification data used to access the customer account include, but are not limited to: cart number, order number, customer email address, customer phone number and customer name.

Responsive to receiving the identification data, the customer service assistance computing system 220 generates an agent user interface 830 presentable to the customer service agent at the customer service agent device 130. The agent user interface 254 presented at the customer service agent device 130 includes access to the customer account information associated with the identification data. The customer account information, among other customer related data, may include user ID 420, name 430, email address 440, shipping and billing address 450, payment information 480. The customer account information also includes active shopping cart information 460 and historical order information 470 of the customer.

It is noted that in certain examples, some portions of the customer account information may be obscured or excluded from view from the customer service agent based on the identity and credentials of the customer service agent, or the manner in which customer account information is accessed. One example of customer account customization may include the following: some customer service agents may not be able to view some forms of customer payment information while other agents may be able to view the same. For example, a customer service agent may not be able to view a customer's credit/debit card information, but a supervisor may have access to the same information, or the customer service agent may have access to such information if such access is provided from a trusted computing terminal. Data related to the customer account is stored in the customer account information database 410 and is illustrated in FIG. 4. An example of the agent user interface 254 is described in more detail in conjunction with FIG. 8, below.

The customer service agent then enters instructions, on the agent user interface 900, to be executed by the customer service assistance computing system 220. The customer service assistance computing system 220 receives the user input entered by the customer service agent 840.

Responsive to the user input from the customer service agent 840, the customer service assistance computing system 220 receives instructions to select and perform a function affecting the customer account 850.

Upon receipt of such instructions, the customer service assistance computing system 220 executes the instructions, thereby affecting the customer account 860. The user input from the customer service agent at the customer service agent device 130 includes input associated with the at least one administrative option selectable by the customer service agent to execute a function affecting the customer account, wherein the at least one administrative option is unavailable to the customer. In other words, the customer service agent has access to options that edit the customer account in ways that the customer cannot. In the disclosed example, the administrative option includes issuing a price modification or issuing a price concession based on price matching to a competitor price for the same product.

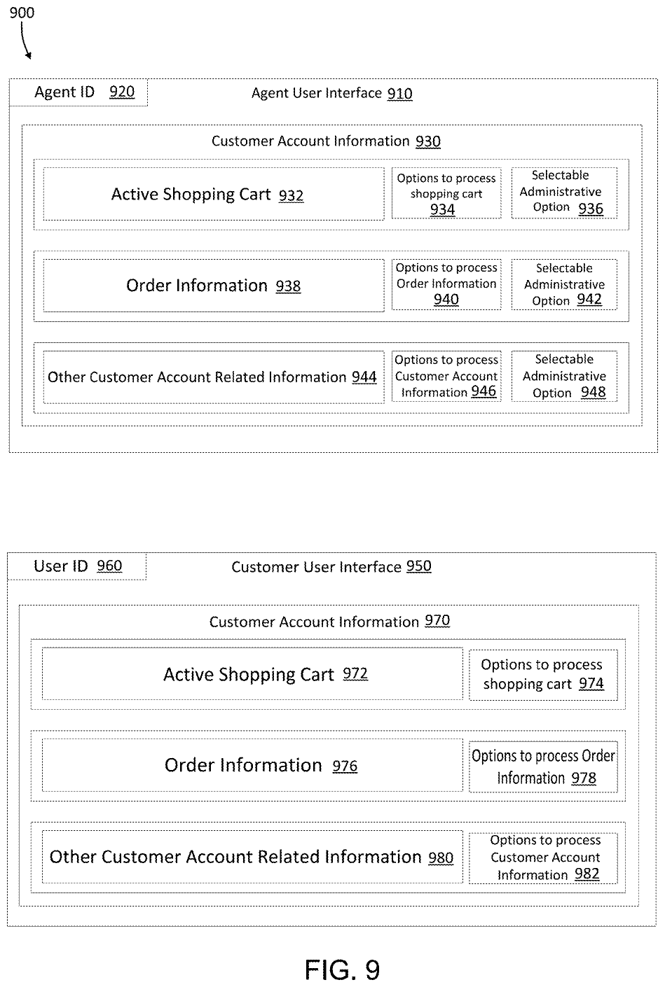

FIG. 9 illustrates an example agent user interface 910, as seen by the customer service agent, and an example customer user interface 950, as seen by the customer. The agent user interface 910 is one example of the agent user interface 254 described above. In the example shown, the customer service agent may initially supply credentials to verify his/her identity as an agent. Based on the identification data supplied by the customer service agent, the agent user interface 910 may be custom generated. The agent's identification or agent ID 920 may be displayed on the agent user interface 910. One or more customer account information 930 belonging to the customer or customers the agent is currently assisting may be displayed within the agent user interface 910. The customer account information 930 may include a graphical representation of the active shopping cart 932, order information 938, and other customer account related information 944.

The active shopping cart 932 may include one or more options to process shopping cart 934 and at least one selectable administrative option 936 that affects the active shopping cart, available to the customer service agent, but otherwise unavailable to the customer. The one or more options to process shopping cart 934 may include modifying the price of one or more items within the active shopping cart and/or issuing a concession or discount for the one or more items within the active shopping cart. A selectable administrative option 936 available to the customer service agent when accessing a customer's active shopping cart 932 may include, modifying the price, and/or issuing a discount or concession for one or more items within the pre-checkout active shopping cart.

The order information 938 may include one or more options to process order information 940, and at least one selectable administrative option 942 that affects the order information, available to the customer service agent, but otherwise unavailable to the customer. The one or more options to process order information 940 may include: checking on order status, reviewing items in the order, checking on shipping status and tracking shipment of order items. A selectable administrative option 942 available to the customer service agent when accessing the customer's order information 938, may include, among others: issuing a discount or concession for one or more items within the pre-checkout active shopping cart.

The other customer account related information 944 may include one or more options to process the customer account information 946 and at least one selectable administrative option 948 that affects the customer account, available to the customer service agent, but otherwise unavailable to the customer. The one or more options to process customer account information 946 includes: editing the customer's personal information, adding or editing shipping address, adding or editing payment information, adding or editing gift card information, and adding or editing account settings. A subset of selectable administrative options 948 available to the customer service agent when accessing the customer's account information 944 may include, among others: disabling the customer account.

The customer may supply credentials to verify his/her identity and populate the customer user interface 950 with his/her customer account information 970. The customer's identification or user ID 960 may be displayed on the customer user interface 950. The customer account information 970 includes a graphical representation of the customer's active shopping cart 972, order information 976, and other customer account related information 980. The graphical representation of the customer's active shopping cart 972 may include one or more options to process the active shopping cart 974. The one or more options to process shopping cart 974 may include: adding an item, editing the number of items, deleting an item, entering a coupon code, and checking out shopping cart. The order information 976 may include one or more options to process the order information 978. The one or more options to process order information 978 may include: checking on order status, reviewing items in the order, checking on shipping status and tracking shipment of order items. The other customer account related information 980 may include one or more options to process the customer account information 982. The one or more options to process customer account information 982 includes: editing the customer's personal information, adding or editing shipping address, adding or editing payment information, adding or editing gift card information, and adding or editing account settings.

The graphical representation of the active shopping cart 972 presented in the customer user interface 950 and the graphical representation of the active shopping cart presented in the agent user interface 910 both derive its data from the same shopping cart information data store 500. The customer user interface 950 displays the active shopping cart 972 to the customer where the customer is able to update the shopping cart items by adding, removing or editing the items in the cart. As the active shopping cart is updated, the corresponding data is stored in the shopping cart information data store 500.

In accordance with the user interfaces disclosed in FIG. 8, when the customer requests assistance from a customer service agent regarding one or more aspects of the active shopping cart, the customer service agent is able to input the customer's identification data and the active shopping cart of the customer is presented to the customer service agent through the agent user interface 910. The active shopping cart 932 presented to the agent also derives its underlying data from the same shopping cart information data store 500 as the customer user interface 950. Similarly, the order information 976 presented to the customer through the customer user interface 950 and the order information 938 presented to the customer service agent through the agent user interface 910 both derive its data from the same order information data store 600. And the other customer account related information 980 presented to the customer through the customer user interface 950 and the other customer account related information 944 presented to the customer service agent through the agent user interface 910 derive its data from the same customer account information data store 400. Accordingly, the customer service agent can view the exact active shopping cart and order information viewed by the customer and can directly make modifications to the items within the pre-checkout active shopping cart and items within orders already placed, including applying discounts or concessions to one or more items to match the price of the one or more items to a competitor price for the same one or more times.

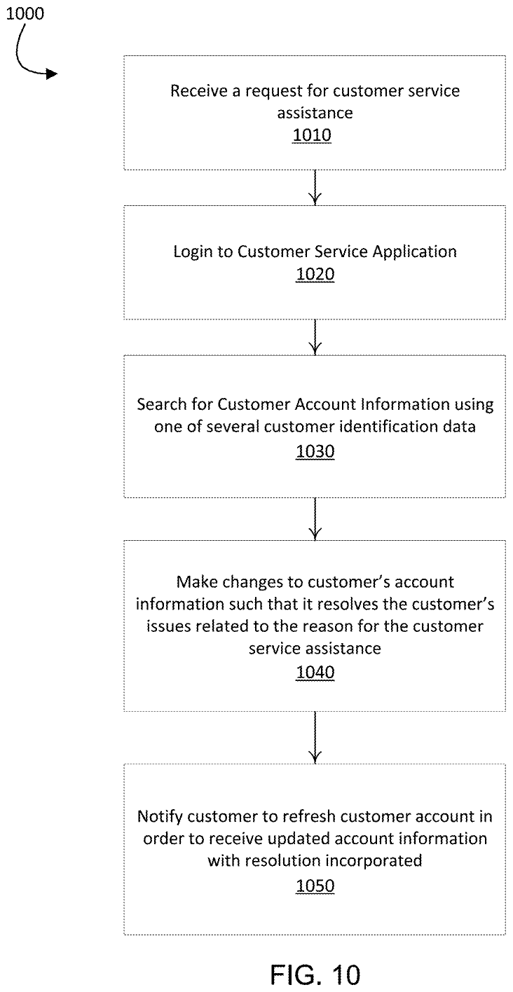

FIG. 10 illustrates a flowchart 1000 showing an example set of operations executed by a customer service agent in assisting a customer. The process begins when a customer service agent receives a request for customer service assistance (operation 1010) from a customer. The customer service agent logs in to the customer service application (operation 1020) to begin the process of assisting the customer. The customer service application 252 is described in more detail under FIG. 2.

After the customer service agent logs in, the customer service application 252 presents the customer service agent with a screen that allows the customer service agent to search for customer account information using one of several customer identification data (operation 1030) associated with the customer. The customer identification data may include one of: order ID, cart ID, email address, phone number, name, and user ID. The customer service agent can then navigate the customer account associated with the customer needing assistance. The customer account viewed by the customer service agent is populated using updated data from the exact same data stores as that used to populate the customer account viewed by the customer. Therefore, the data in the customer account is up to date and allows the customer service agent to essentially view what the customer is viewing.

The customer service agent can then make changes to the customer's account information, including the customer's pre-checkout active shopping cart information and/or the customer's post-checkout order information, such that it resolves the customer's issues related to the reason for the customer service assistance (operation 1040). The customer's issues could be related to requesting a price modification or concession related to an item within the customer's active shopping cart, or a previous order. In any case, once the customer service agent gains access to the customer account information, the customer service agent is free to navigate to the appropriate section of the account to make edits in order to best serve the needs of the customer.

Once the customer service agent has completed making changes to the customer account necessary to resolve the customer's issues, the customer service agent may notify the customer to refresh their customer account in order to receive the updated account information with resolution incorporated (operation 1050). By refreshing their customer accounts, the customer may receive updated customer account information that automatically has the customer service agent's changes incorporated into it, thus resolving any customer issues efficiently.

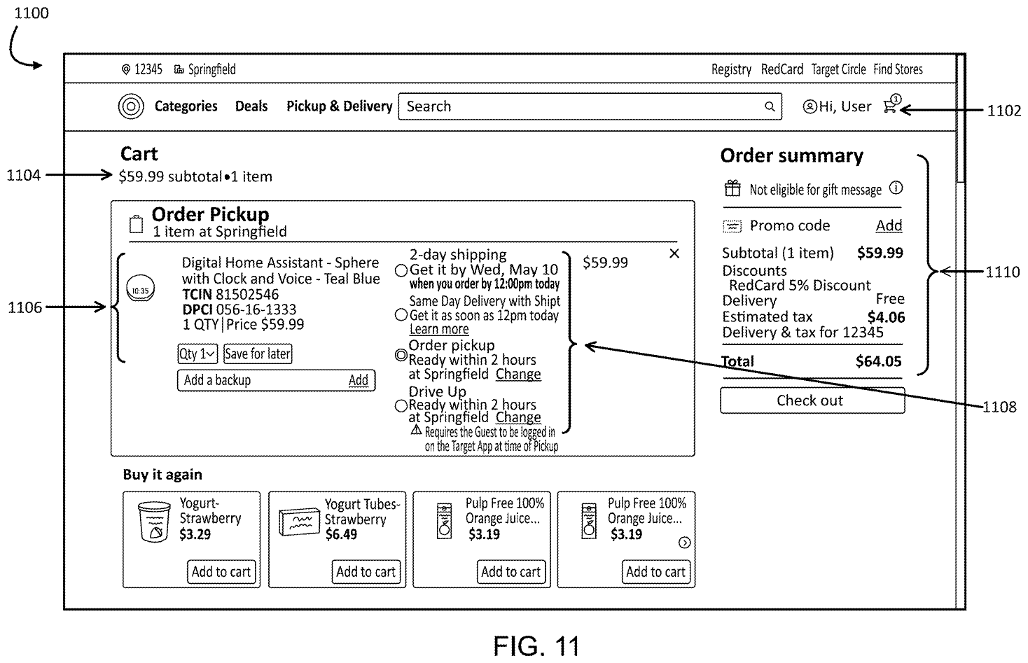

Referring now to FIGS. 11-19, a series of example detailed user interfaces are provided that illustrate various ways in which a customer service assistance system 200 may generate a customer user interface and/or an agent user interface that allows a customer service agent to quickly view the status of a customer's account information, identify pricing issues in that account information, verify whether the price needs to be modified and/or a concession should be issued and resolve the pricing issues by using administrative options on those user interfaces which are not otherwise available to the customer.

FIG. 11 illustrates an example customer user interface 1100 as generated by the customer service assistance system 200 of FIG. 2. The customer user interface 1100 illustrates a pre-checkout order summary page as displayed on a customer device 120. In general, the customer may arrive at the customer user interface 1100 after navigating through one or more webpages associated with the retailer to conduct online shopping of one or more items. The customer may arrive at the customer user interface 1100 by selecting a graphical representation of an active shopping cart 1102 within the one or more retailer webpages that the customer is navigating through while conducting the online shopping session. Other ways of arriving at the customer user interface 1100 is also possible.

The customer user interface 1100 is configured to display a summary of the one or more items that the customer has added to an active shopping cart 1102. The summary of the one or more items may include a display of the order subtotal amount 1104, a listing of the items 1106 included within the active shopping cart 1102, a listing of shipping options 1108 associated with the one or more items within the active shopping cart 1102, and an order summary pricing information 1110.

The order subtotal amount 1104 displays a subtotal price of the one or items included within the active cart 1102. The subtotal amount only includes the price of the items themselves and does not include additional costs and fees such as shipping fees, delivery fees, tax, discounts, etc. In the example customer user interface 1100, the order subtotal amount is listed as $59.99.

The listing of the items 1106 included within the active shopping cart 1102 lists one or more items that the customer has added to the active shopping while shopping online on the retailer's webpage. The listing of the items 1106 may include the name of each of the one or more items included within the active shipping cart 1102, one or more internal item listing and identifier numbers, the quantity or number of the same item that is added to the active shopping cart 1102, and the listed price for each of the items. Other types of information may also be included for each of the items included within the listing of items 1106. In the example customer user interface 1100, the listing of the items 1104 only includes 1 item, an “Digital Home Assistant—Sphere with Clock and Voice—Teal Blue”.

The listing of shipping options 1108 associated with the one or more items within the active shopping cart 1102 includes a listing of each type of shipping option available for the item, which includes options for picking up the item from a retail location and options for driving up to the retail location where the item is loaded into the customer's vehicle, an estimated delivery date of the item if the particular shipping option is selected, or an estimated timeframe at which the customer can pickup the item from a particular retail location and an option to change the pickup retail location. In the example customer user interface 1100, the listing of shipping options 1108 includes an option for 2-day shipping, same day delivery, order pickup option and an order drive up option.

The order summary pricing information 1110 includes a summary of the pricing information for the one or more items include within the active shopping cart 1102. The order summary pricing information may include the subtotal amount for each item included within the active shopping cart 1102, total subtotal amount for all of the items included within the active shipping cart 1102, any discounts that may be applied towards the one or more items included within the active shopping cart 1102, any shipping or delivery fees that may be applied towards the one or more items included within the active shopping cart 1102, estimated taxes that may be applied towards the one or more items included within the active shopping cart 1102 and a total price that encompasses the total subtotal amount, the discounts, shipping or delivery fees and estimated taxes. In other words, the total price is the total amount that the customer would be charged to purchase the one or more items included with the active shopping cart 1102.

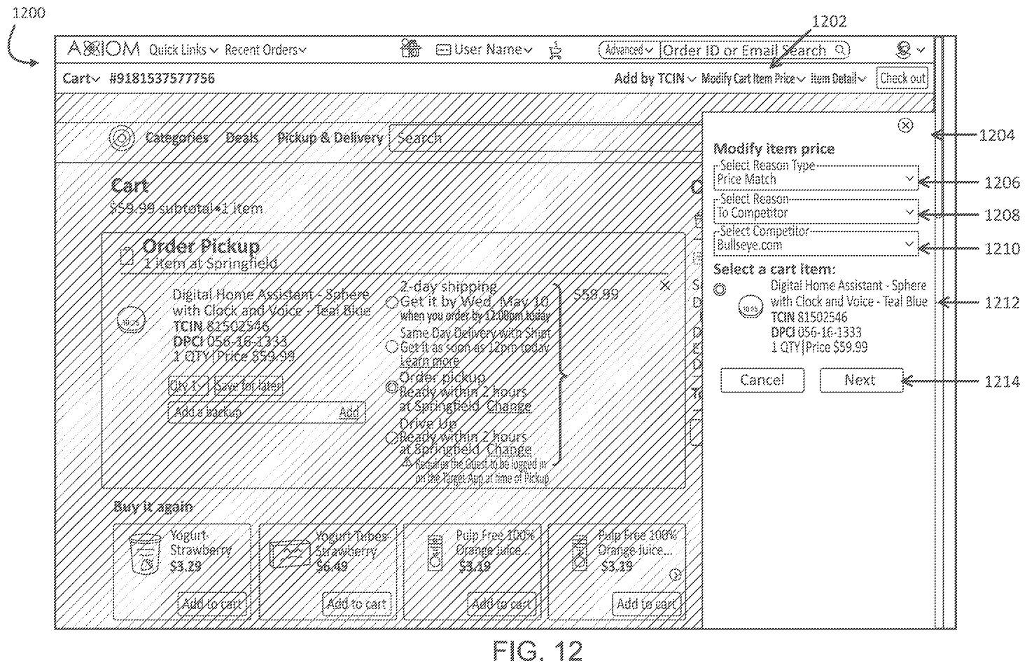

FIG. 12 illustrates an example price modification agent user interface 1200 as generated by the customer service assistance system 200 of FIG. 2. In general, the customer service agent may arrive at the price modification agent user interface 1200 upon the customer service agent selecting an option to modify the price of an item within a customer's active shopping cart. For example, the customer service agent may have received a request from a customer requesting that the customer service agent match the price of an item within the customer's active shopping cart to the price of the same item as listed on a competitor's retail store, a competitor's online webpage or on the retailer's own print or online advertisement. The customer service agent may arrive at the price modification agent user interface 1200 upon the customer service agent searching for and pulling up the customer's account information and selecting a “Modify Cart Item Price” option 1202.

Selecting the “Modify Cart Item Price” option 1202 within the price modification agent user interface 1200 causes the price modification agent user interface 1200 to be updated to display a “modify item price” panel 1204 as an overlay on a portion of the price modification agent user interface 1200. Other ways of displaying the “modify item price” panel 1204 is also possible.

The “modify item price” panel 1204 may have one or more options that are selectable by the customer service agent. The one or more options may include a “select reason type” option 1206, a “select reason” option 1208, an optional “select competitor” option 1210 and “select a cart item” option 1212. Other options are also possible. Each of the one or more options may have a plurality of selections for the customer service agent to select from. The list of options 1206-1210 and the list of selections withing each of the list of options 1206-1210 displayed on the “modify item price” panel 1204 may dynamically be updated based on the selections selected by the customer service agent for the one or more options.

The “select reason type” option 1206 may include a drop-down menu that is configured to display a plurality of selections that describe the types of reasons why the customer service agent may modify an item price. For example, the plurality of selections associated with the “select reason type” option 1206 may include: item damaged or defective, delays in fulfilment, price match, and other. Other selections are also possible.

The “select reason” option 1208 may include a drop-down menu that is configured to display a plurality of selections that describe the reasons why the customer service agent may modify the item price. For example, the plurality of selections associated with the “select reason” option 1208 may include: to retailer advertised price, to competitor price, reorder price that matches previous price of item, pre-order price change. Other selections are also possible.

The “select competitor” option 1210 is an optional option that gets populated if and when the customer service agent selects the “price match” selection for the “select reason type” option 1206 and the “to competitor price” selection for the “select reason option 1208. If the customer service agent selects a different option for the “select reason type” option 1206 or the “select reason” option 1208, the “select competitor” option 1210 may not be displayed on the “modify item price” panel 1204.

The “select a cart item” option 1212 is configured to display the list of items included within the customer's active shopping cart 1102 along with a radio button adjacent to each of the items in the list that the customer service agent may then select between. The “select a cart item” option 1212 allows the customer service agent to select the item within the customer's active shopping cart 1102 that the customer service agent is currently considering to price modification for. The customer service agent may only select one of the items from the list of items included within the customer's active shopping cart 1102 at a time. In the current example from the “modify item price” panel 1204, the only item listed under the “select a cart item” option 1212 is the “Digital Home Assistant—Sphere with Clock and Voice—Teal Blue”, which has been selected by the customer service agent as the item requiring a modification in price based on the selection of the radio button displayed adjacent to the listing of the item on the “modify item price” panel 1204.

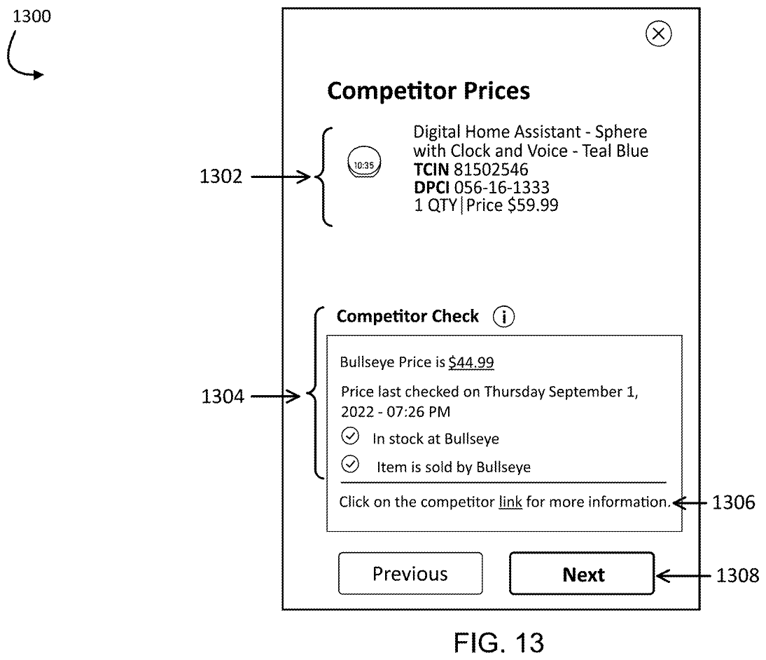

Upon making selection for each of the one or more options, the customer service agent may select a “next” option 1214 to navigate from the “modify item price” panel 1204 to the “competitor prices” panel 1300. The “competitor prices” panel 1300 is described further in relation to FIG. 13.

FIG. 13 illustrates an example “competitor prices” panel 1300 of the price modification agent user interface 1200 as generated by the customer service assistance system 200 of FIG. 2. Although the “competitor prices” panel 1300 is illustrated independently, the “competitor prices” panel 1300 is configured to replace the “modify item price” panel 1204 as an overlay on the price modification agent user interface 1200 upon the customer service agent selecting the “next” option 1214 on the “modify item price” panel 1204. Other ways of displaying the “competitor prices” panel 1300 are also possible.

The “competitor prices” panel 1300 includes a price modification item listing summary

1302 that lists information related to the selected item for which the customer service agent is in the process of modifying the price for. The price modification item listing summary 1302 may list the name of the selected item, which in the example from FIG. 13 is “Digital Home Assistant—Sphere with Clock and Voice—Teal Blue”. The price modification item listing summary 1302 may also list a retailer identification number, which in the example from FIG. 13 is the TCIN and DPCI number, the quantity of each of the items, which in the example from FIG. 13 is 1, and the listed price for each of the items, which in the example from FIG. 13 is $59.99.

The “competitor prices” panel 1300 also includes a competitor check section 1304. The competitor check section 1304 is configured to check whether a competitor price, which in some examples may include the retailer's own advertised price or listing with a different price, qualifies for a price match. The competitor check section 1304 lists a competitor price for the item, a date and time at which the competitor price for the item was last retrieved, whether the item is in stock at the competitor, and whether the item is sold by the competitor. In the example from FIG. 13, the competitor price is listed as $44.99, which would be $15 lower than the retailer's listed price of $59.99. The information listed within the competitor check section 1304 is retrieved from the pricing database 710.

For example, once the customer service agent selects an item under the “select a cart item” option 1212 and a name of a competitor in the “select competitor” option 1210 from the “modify item price” panel 1204, the pricing database 710 is checked to see if an entry includes an item ID 740 that matches the selected cart item and a source 750 that matches the selected competitor. If so, an automatic competitor check process is performed on the information associated with the particular entry, including the date 720, the time 730, the listed price 760, the stock status 770, the item sold by/fulfilled by 780 and notes regarding pricing 790, within the pricing database 710 to determine whether the particular competitor price qualifies for a price match.

For example, the competitor check process may include (i) verifying that the listed price 760 for the entry within the pricing information database 710, which lists the competitor's price for the product, is in fact lower than the subtotal amount offered by the retailer, (ii) verifying that the stock status 770 for the entry within the pricing information database 710 states that the item is in fact in-stock and available for sale by the competitor, (iii) verifying that the item sold by/fulfilled by 780 for the entry within the pricing information database 710 states that the items is in fact offered for sale by and fulfilled by the competitor themselves instead of a third party entity and (iv) verifying that all of the information, including the listed price 760, stock status 770, item sold by/fulfilled by 780 is up-to-date by determining whether the date 720 and time 730 at which the entry was last updated is within a predetermined threshold timeframe. The predetermined threshold timeframe may be any time frame that the retailer may determine to be reasonable to honor a price match offer. In some examples, the predetermined threshold timeframe may be a few days. In other examples, the predetermined threshold timeframe may be within the same day.

Once the competitor check process validates that each of the conditions (i)-(iv) listed above, the “competitor prices” panel 1300 may include a graphical representation that the condition was validated. In the example from FIG. 13, once validated, a green check mark in a circle is added adjacent to the listing of each of the conditions—listed price, stock status, item sold by/fulfilled by. In addition, the date and time at which the information was last checked is also listed. In case a condition fails the validation process, a red “x” mark in a circle may be displayed adjacent to the listing.

The “competitor prices” panel 1300 also includes link 1306 to the competitor's online listing for the item. Selecting the link 1306 allows the customer service agent to navigate to the competitor's webpage that lists the item. Upon navigating to the competitor's webpage listing the item, the customer service agent may verify whether there are any updates to the price, stock status, etc of the item since the date and time at which the information was last retrieved by the customer service assistance system 200. The customer service agent may verify the competitor's listing in a manual process by selecting the link and navigating to the competitor's webpage as a supplementary process to the automatic competitor check process described above.

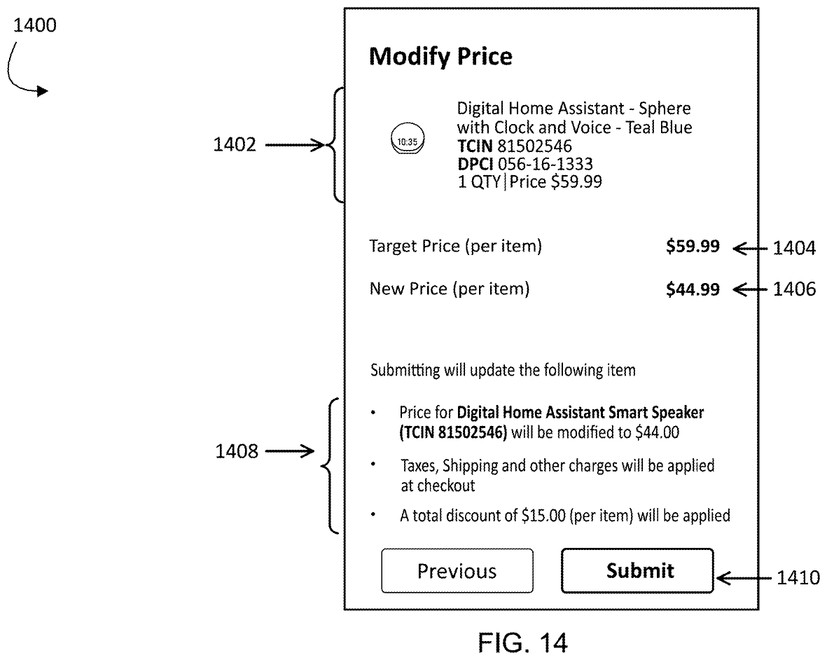

Upon completing the competitor check process, if the customer service assistance system 200 determines that the competitor price in fact qualifies for a price match or a price modification, the “competitor prices” panel 1300 displays a “next” option 1308. The customer service agent may select the “next” option 1308 to navigate from the “competitor prices” panel 1300 to the “modify price” panel 1400. The “modify price” panel 1400 is described further in relation to FIG. 14.

FIG. 14 illustrates an example “modify price” panel 1400 of the price modification agent user interface 1200 as generated by the customer service assistance system 200 of FIG. 2. Although the “modify price” panel 1400 is illustrated independently, the “modify price” panel 1400 is configured to replace the “competitor prices” panel 1300 as an overlay on the price modification agent user interface 1200 upon the customer service agent selecting the “next” option 1308 on the “competitor prices” panel 1300. Other ways of displaying the “modify price” panel 1400 are also possible.

The “modify price” panel 1400 includes a price modification item listing summary 1402 that lists information related to the selected item for which the customer service agent is in the process of modifying the price for. The price modification item listing summary 1402 may list the name of the selected item, which in the example from FIG. 14 is “Digital Home Assistant—Sphere with Clock and Voice—Teal Blue”. The price modification item listing summary 1402 may also list a retailer identification number, which in the example from FIG. 14 is the TCIN and DPCI number, the quantity of each of the items, which in the example from FIG. 14 is 1, and the listed price for each of the items, which in the example from FIG. 14 is $59.99.

The “modify price” panel 1400 also includes a retailer listed price1404 and the modified price 1406. The retailer listed price 1404 includes the retailer's listed price for the item from the active shopping cart, as listed in the price modification item listing summary 1402, prior to any price modifications by the customer service agent. In the example from FIG. 14, the retailer listed price 1404 is $59.99. The modified price 1406 includes the price for the item from the active shopping cart, as listed in the price modification item listing summary 1402, after the price modification is applied to the retailer listed price 1404 by the customer service agent. In the example from FIG. 14, the modified price 1406 is $44.99, which matches the competitor price as listed and verified in the competitor check section 1304 of FIG. 13.

The “modify price” panel 1400 includes a price modification summary section 1408 that lists a summary of the price modification based on the price check process thus far, as described in relation to FIGS. 11 and 12. The price modification summary section 1408 includes a listing of the item for which the price modification is to be applied if the price modification process is completed. The name of the item within the listing of the item matches the name of the item as included in the price modification item listing summary 1402. In addition, the listing of the item also lists the modified price, the reduction in price that the customer will receive, which is the difference between the retailer listed price 1404 and the modified price 1406. In the example from FIG. 14, the price modification summary section 1408 states that a total discount of $15.00 will be applied to the retailer listed price 1404, which is the difference between the retailer listed price 1404 of $59.99 and the modified price 1406 of $44.99.

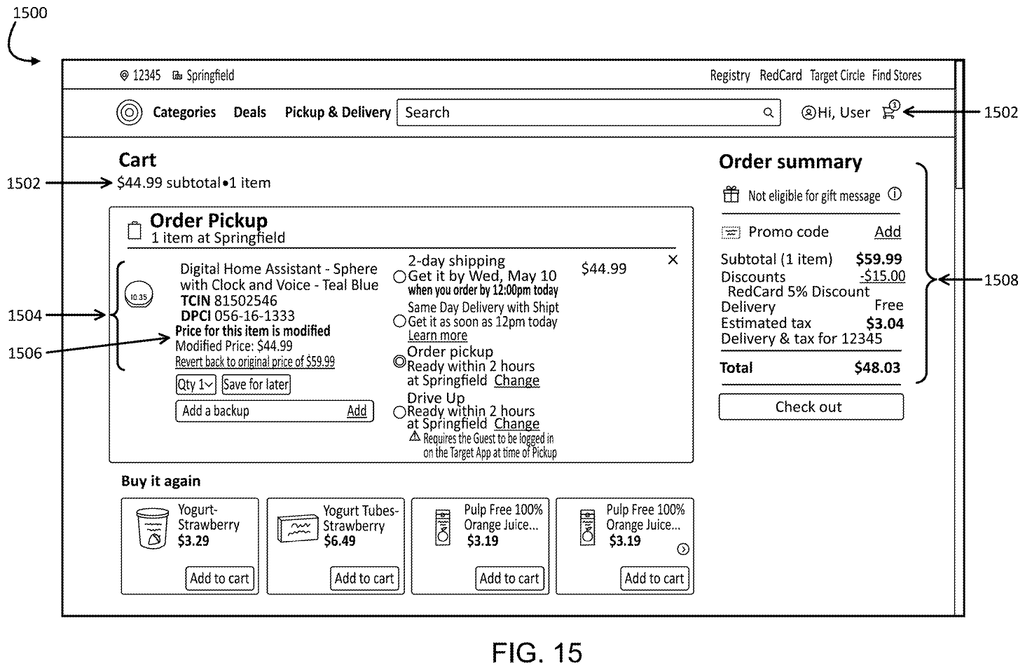

Once the customer service agent verifies that the information listed within the “modify price” panel 1400 is accurate, the customer service agent may select the “submit” button 1410 to finalize the price modification. Upon the customer service agent selecting the “submit” button 1410, the order subtotal amount 1104 on the customer user interface is automatically updated to display the price as the modified price 1406 to reflect the price match submitted by the customer service agent on the price modification agent user interface 1200. The updates to the customer user interface 1100 are discussed further in relation to FIG. 15.

FIG. 15 illustrates another example customer user interface 1500 as generated by the customer service assistance 200 of FIG. 2. The customer user interface 1500 illustrates a pre-checkout order summary page after a customer service agent has modified the price of an item within the customer's active shopping cart. In general, the customer user interface 1500 is generated upon the customer service agent completes the price modification process, as described in relation to FIGS. 12-14 after receiving a request from a customer regarding modification of a price for one or more items in the customer's active, pre-checkout shopping cart as described in relation to FIG. 11. The customer user interface 1500 is displayed on the customer device 120 when the customer refreshes the customer user interface 1100.

The customer user interface 1500 is configured to display a summary of the one or more items that the customer has added to an active shopping cart 1500. The contents of the active shopping cart 1502 is the same as the contents of the active shopping cart 1102, however, the active shopping cart 1502 is displayed on the customer user interface 1500, while the active shopping cart 1102 is displayed on the customer user interface 1100. The customer user interface 1500 may include a display of the modified order subtotal amount 1504, a listing of the items 1506 included within the active shopping cart 1502, a summary of the price modification 1508 associated with the one or more items within the active shopping cart 1502, and a modified order summary pricing information 1510.

The modified order subtotal amount 1504 displays the modified subtotal price 1502 of the one or items included within the active cart 1502. The modified subtotal price 1502 reflects the price of the one or more items after the customer service agent has modified the price during a price modification process as described in FIGS. 12-14. The modified subtotal price does not include additional costs and fees such as shipping fees, delivery fees, tax, discounts, etc. In the example customer user interface 1100, the order subtotal amount is listed as $44.99.

The listing of the items 1506 included within the active shopping cart 1502 lists one or more items that the customer has added to the active shopping while shopping online on the retailer's webpage. The listing of items 1506 is generally the same as the listing of items 1106 displayed on the customer user interface 1100 with the exception of a display of the summary of the price modification 1508.

The summary of the price modification 1508 is a display of the how the subtotal price 1106 from FIG. 11 was modified by the customer service agent after the customer made a request for a price modification. For each item of the list of items included within the active shopping cart 1502 that has been modified in price by the customer service agent, the summary of the price modification 1508 displays a note saying that the price has been modified and also displays the modified price item for that item. The summary of the price modification 1508 may be visually represented using a contrasting color, font type or font size in order to clearly convey to the customer that modifications made by the customer service agent. In the example from FIG. 15, the, the summary of the price modification 1508 states that “the price has been modified” and states the modified price to be $44.99.

In addition the modified price, the summary of the price modification 1508 may also include a selectable option to revert back to the original price. For example, the customer, for whatever reasons, may want to revert back to an original price of the item instead of accepting the price modification provided by the customer service agent. In such cases, the customer may select the “revert back to original price” option within the summary of the price modification 1508 in order for the modified price for the particular item to revert back to the original price, as would be listed in the example customer user interface 1100 from FIG. 11.

The modified order summary pricing information 1510 includes a summary of the pricing information for the one or more items include within the active shopping cart 1502. The modified order summary pricing information 1510 may include the original total subtotal amount for all of the items included within the active shipping cart 1502 prior to the application of any price modifications, the discount amount, which is the amount by which the customer service agent has modified the total original total subtotal amount, any shipping or delivery fees that may be applied towards the one or more items included within the active shopping cart 1502, estimated taxes that may be applied towards the one or more items included within the active shopping cart 1502 and a total price that encompasses the total subtotal amount, the discounts, shipping or delivery fees and estimated taxes. In other words, the total price is the total amount that the customer would be charged to purchase the one or more items included within the active shopping cart 1502 after the application of the price modification by the customer service agent. In the example from FIG. 15, the original total subtotal amount is listed as $59.99, the price modification from $59.99 to $44.99 is listed as the discount amount, the shipping or delivery fee is listed as “Free” and the estimated taxes is listed as $3.04. The total modified price for all the items within the active shopping cart 1502 is listed as $48.03.

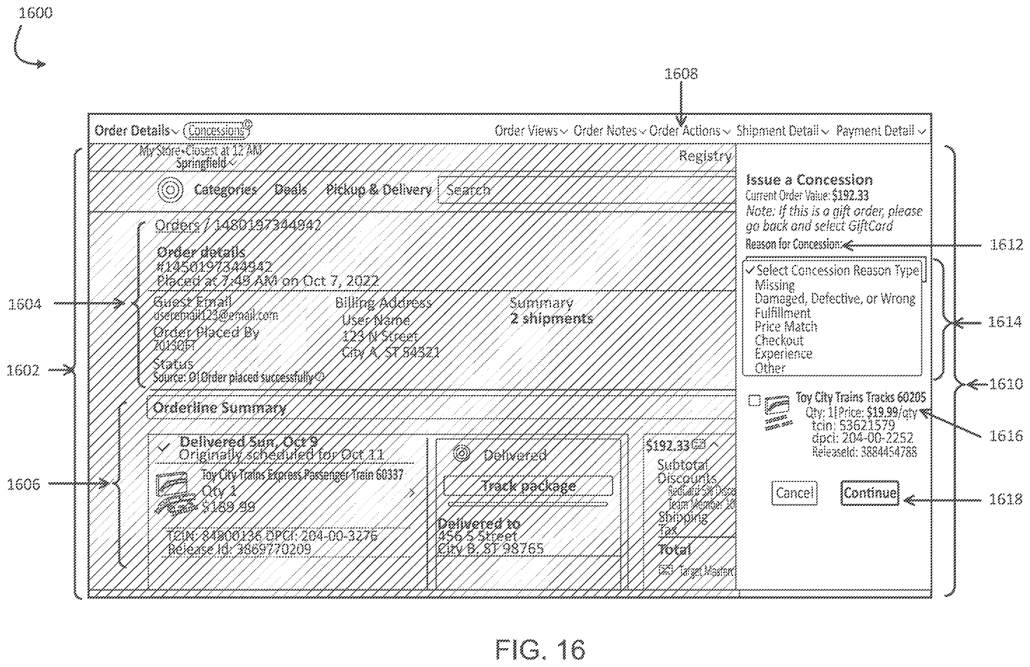

FIG. 16 illustrates an example issue concession agent user interface 1600 as generated by the customer service assistance system 200 of FIG. 2. In general, when a customer who has already purchase one or more items at a retailer contacts the customer service agent requesting to receive concession for one or more items that have already been purchased due to any number of reasons including price matching, the item being missing, damaged or defective, the item arriving later than expected, the item functioning differently than advertise or as compensation for a bad experience, the customer service agent may make the decision to issue a concession to the customer. If so, the customer service agent may use the issue concession agent user interface 1600 to efficiently issue the concession.

For example, the customer service agent may arrive at the issue concession agent user interface 1600 that displays the “issue a concession” panel 1610 upon opening up an agent user interface 254, entering identifying information about the account of the customer currently requesting the issuance of a concession, navigating to the order details page 1602 of the customer's account and selecting the “issue a concession” option under the “order actions” option 1608.

For example, upon arriving at the order details page 1602 of the customer's account, the user interface may display an order details section 160 that includes information such as: the order number, the date and time at which the order was placed, the status of the order, etc, and an order summary section 1604 that includes a details regarding the items included within the order itself. The order detail section 1606 may also have certain information, such as billing and payment information hidden from the customer service agent in order to protect the customer's privacy. Such hidden information may be uncovered based on the level of access the customer service agent is granted. For example, a supervisor customer service agent may be granted access to information that is hidden from a staff customer service agent.

The order details page 1602 of the customer's account as displayed on the agent user interface includes a number of options listed on the top of the display that are only accessible to the customer service agent, including a “order actions” option 1608. The “order actions” option 1608 grants the customer service agent access to one or more administrative options to change or edit the customer's post-purchase order that is otherwise not available to the customer. The list of administrative options may include a “cancel the order” option, “change the order” option, “change the billing information” option, “change the shipping information” option, and an “issue a concession” option. Other options may also be included for selection within the “order actions” option 1608.

Upon selection of the “issue a concession” option, the agent user interface may be updated to include an initial “issue a concession” panel 1610 as an overlay to the order details page 1602, which together is the issue concession agent user interface 1600. The initial “issue a concession” panel 1610 includes one or more options that may dynamically expand into additional options based on the selections made for the one or more options.

The one or more options included in the initial “issue a concession” panel 1610 includes a “reason for concession” option 1612. The “reason for concession” option 1612 may be a drop-down menu option that when selected displays one or more selectable listings 1614 to select from. For example, the one or more selectable listings 1614 may include: “reason for concession” option 1612 may list “missing”, “damaged, defective, or wrong”, “fulfillment”, “price match”, “checkout”, “experience” and “other”. More, less or different listing may be included within the one or more selectable listings 1614.

The initial “issue a concession” panel 1610 may also display a list of order items 1616 included within the customer's order along with a selection button or a radio button adjacent to each of the items in the list of order items 1616 that the customer service agent may then select from. The list of order items 1616 allows the customer service agent to select one or more items within the customer's order that the customer service agent is currently considering to issue a concession for. In the current example from the initial “issue a concession” panel 1610, the only item listed under the list of order items 1616 is the “Toy City Trains Tracks 60205”, which can be selected by the customer service agent as the item requiring a concession in price.

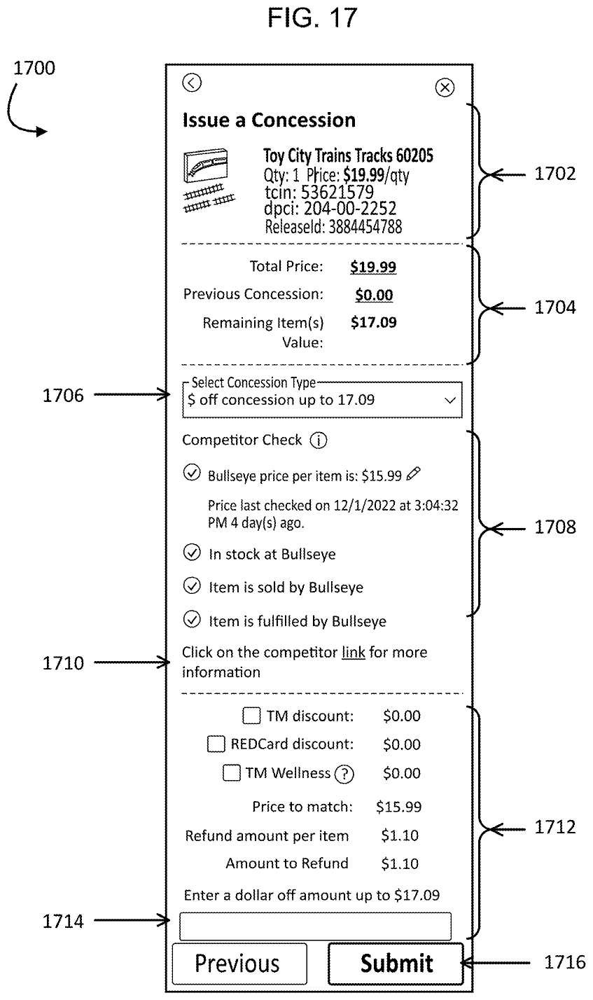

Upon making one or more selections within the initial “issue a concession” panel 1610, the customer service agent may select a “continue” option 1618 to navigate from the initial “issue a concession” panel 1610 to the final “issue a concession” panel 1700. Although the current example shows transitioning from the initial “issue a concession” panel 1610 to the final “issue a concession” panel 1700 upon selecting the “continue” option 1618, in other examples, there may be one or more intermediate “issue a concession” panels with additional options for the customer service agent to select from. The final “issue a concession” panel 1700 is described further in relation to FIG. 17.

FIG. 17 illustrates an example final “issue a concession” panel 1700 of the issue concession agent user interface 1600 as generated by the customer service assistance system 200 of FIG. 2. Although the final “issue a concession” panel 1700 is illustrated as being displayed independently, the final “issue a concession” panel 1700 is configured to replace the initial “issue a concession” panel 1610 as an overlay on the issue concession agent user interface 1600 upon the customer service agent selecting the “continue” option 1618 on the initial “issue a concession” panel 1610. Other ways of displaying the final “issue a concession” panel 1700 are also possible.

The final “issue a concession” panel 1700 includes an issue concession item listing summary 1702 that lists information related to the selected item for which the customer service agent is in the process of issuing a concession. The issue concession item listing summary 1702 may list the name of the selected item, which in the example from FIG. 17 is “Toy City Trains Tracks 60205”. issue concession item listing summary 1702 may also list a retailer identification number, which in the example from FIG. 17 is the TCIN and DPCI numbers, the quantity of each of the items, which in the example from FIG. 17 is 1, and the listed price for each of the items, which in the example from FIG. 17 is $19.99.

The final “issue a concession” panel 1700 includes a remaining item value summary 1704 that lists the total price of the item for which the concession is being issued. The remaining item value summary 1704 is configured to present the remaining value of an item that a concession can be applied towards. For example, typically, an item's total price may include the subtotal price of the item itself, taxes associated with the item, any fees, discounts and/or previous concessions applied to the item. However, a concession is typically only applied to the subtotal price itself and does not apply to any additional taxes or fees associated with the item.

The remaining item value summary 1704 displays a list of the total price of the item, any previously applied concession amount and the remining item value. The total price of the item includes a summary of the item's subtotal price along with taxes, fees, previously applied concession, and/or discounts. In the example from FIG. 17, the total price of the item is $19.99. The previously applied concession amount lists the value of any concessions that were previously applied towards the item. In the example from FIG. 17, the previously applied concession amount is $0. The remaining item value is the value of the item minus any taxes and fees. In the example from FIG. 17, the remining item value is $17.09. Although in the example from FIG. 17, only one item is being considered for a concession, in other examples, multiple items from the same order may be considered for concessions using the same process.

The final “issue a concession” panel 1700 includes a “select concession type” option 1706. The “select concession type” option 1706 is configured to provide a method of providing the concession for the selected item. The “select concession type” option 1706 includes one or more options related to how the concession may be provided to the customer for the selected item or items. In some examples, the “select concession type” option 1706 may use a drop-down menu to display options. In other examples, the “select concession type” option 1706 may display options using a different method. The “select concession type” option 1706 may include the following options: monetary amount off of the item, a percentage off of the price of the item, store credit for a monetary amount, and gift card for a monetary item. Other types of options may also be possible.

In some examples, the concession monetary amount or percentage amount may be applied to the remaining item value, as described in relation to the remaining item value summary 1704. In other examples, the concession monetary amount or percentage amount may be applied to a different amount associated with the item, such as the item's total amount. In the example from FIG. 17, the “select concession type” option 1706 has the “$ off concession up to $17.09” option selected, which indicates that the customer service agent is planning on issuing the concession as a monetary amount off.

The final “issue a concession” panel 1700 includes a concession competitor check section 1708. Similar to the competitor check section 1304 from FIG. 13, the concession competitor check section 1708 is configured to check whether a competitor price, which in some examples may include the retailer's own advertised price or listing with a different price, qualifies for a concession. The concession competitor check section 1708 lists a competitor price for the item, a date and time at which the competitor price for the item was last retrieved, whether the item is in stock at the competitor, and whether the item is sold by the competitor. The information listed within the competitor check section 1708 is retrieved from the pricing database 710.

Similar to the competitor check section 1304 of FIG. 13, once validated, a green check mark in a circle is displayed adjacent to the listing of each of the conditions—listed price, stock status, item sold by/fulfilled by. In case a condition fails the validation process, a red “x” mark in a circle may be displayed adjacent to the listing.

In the example from FIG. 17, the competitor price is listed as $15.99, which would be $1.10 lower than the remaining item value of $17.09. The date and time at which the competitor price for the item was last retrieved is listed as “Price last checked on Dec. 1, 2022 at 3:04:32 PM 4 day(s) ago.” Having the date and time when the competitor price was last checked, and period elapsed since the date and time explicitly displayed helps the customer service agent to understand whether the price matching to a competitor price is reasonable. The stock availability and the sold by/fulfilled by information listed on the concession competitor check section 1708 also helps the customer service agent make the decision whether to issue a concession. For example, the customer service agent may make the decision to deny a concession if the item is not in stock at the competitor, the customer service agent may decide not to issue a concession. Similarly, if the item is not sold by or fulfilled by the competitor, the customer service agent may once again decide to not issue a concession.

In general, the concession competitor check section 1708 provides useful, verified information to the customer service agent that allows the customer service agent to quickly and efficiently make a decision regarding price matching, such as issuing a concession or reducing the price of an item, without having to navigate to additional webpages, verifying the information, and making calculations regarding the maximum amount that the concession or price reduction can be issued for.

Similar to the link 1306 from FIG. 13, the final “issue a concession” panel 1700 may include a competitor link 1710 to the competitor's online listing for the item. Selecting the competitor link 1710 allows the customer service agent to navigate to the competitor's webpage that lists the item. Upon navigating to the competitor's webpage listing the item, the customer service agent may optionally verify whether additional information about the listing, including whether there are any updates to the price, stock status, etc. of the item since the date and time at which the information was last retrieved by the customer service assistance system 200. The customer service agent may verify the competitor's listing in a manual process by selecting the link and navigating to the competitor's webpage as a supplementary process to the automatic competitor check process described above.

The final “issue a concession” panel 1700 may include a concession pricing summary section 1712. The concession pricing summary section 1712 is configured to display a summary of the pricing for the item after the application of a concession. The concession pricing summary section 1712 includes selectable options for various additional discounts that may be applied towards the concession. This includes a team member or employee discount, a discount for retailer card holders, a team member of employee wellness discount. Upon the customer service agent selecting any of the selectable options for the various additional discounts, an additional discount amount may be automatically populated adjacent to the selectable option itself. The customer service agent may select any of these options based on whether the customer is a team member or employee or if the customer owned a credit card associated with the retailer.

In addition to the selectable options, the concession pricing summary section 1712 may also display a “price to match” that displays the price of the item as offered by a competitor and automatically verified in the concession competitor check section 1708 and optionally manually verified by the customer service agent. In the example from FIG. 17, the “price to match” is listed as $15.99, which matches the competitor's price as listed in the concession competitor check section 1708.

The concession pricing summary section 1712 also lists the “refund amount per item”, which initially lists the difference between the remaining item value from the remaining item value summary 1704 and the “price to match” amount. While the “refund amount per item” is initially automatically lists the difference between the remaining item value from the remaining item value summary 1704 and the “price to match” amount, the “refund amount per item” may be dynamically adjusted based on whether the customer service agent's provides a manual “dollar off” amount using the concession manual override amount 1714, described below in further detail. In the example from FIG. 17, the “refund amount per item” is listed as $1.10.

The concession pricing summary section 1712 may also list the “amount to refund.” While the “refund amount per item” lists the amount to refund on a per item basis, the “amount to refund” may summarize the team member or employee discount, a discount for retailer card holders, a team member of employee wellness discount and the “refund amount per item” for each of the items for which concessions are being issued. In the example from FIG. 17, since only one item is being considered for a concession and there are no additional discounts being issued on account of the customer's status as a team member or employee and the customer not using a retailer issued credit card, the “amount to refund” matches the “refund item per item” and is listed as $1.10.

The concession pricing summary section 1712 may also include a concession manual override amount 1714. The concession manual override amount 1714 may include an input entry area that allows the customer service agent to manually enter an amount of money to issue as a concession instead of using the automatically issued refund amount that equals the difference between the remaining item value and the “price to match.” In one example, the customer service agent may enter a concession amount that is up to the remaining item value calculated for display on the remaining item value summary 1704. In other words, the customer service agent may not be authorized to enter a manual override amount that is higher than the item's remaining item value price itself. In other examples, the customer service agents with supervisory status may be able to issue concessions up to a different maximum amount.

Upon the customer service agent entering a concession amount within the input entry area of the concession manual override amount, the “refund amount per item” may be dynamically modified to display the manually entered amount from the input entry area instead of the automatically calculated value as described above. The “amount to refund” may also be dynamically updated based on any changes to the “refund amount per item” value.

Once the customer service agent verifies that the information listed within the “issue a concession” panel 1700 is accurate, the customer service agent may select the “submit” button 1716 to finalize the concession issuance. Upon the customer service agent selecting the “submit” button 1716, the customer's order information on a customer user interface may be automatically updated to display the issued concession amount to reflect the price match submitted by the customer service agent on the issue concession agent user interface 1600. If the order has already been processed and invoiced, the concession amount may be issued to the customer as a refund on the customer's payment method, such as the credit/debit card used. If cash was used, the refund amount may be issued as a store credit or a gift card to the retailer. If the order was not processed or invoiced yet, the concession amount may be issued to the customer as a deduction in the order total amount when invoicing the order. Other ways of refunding the concession amount are also possible.

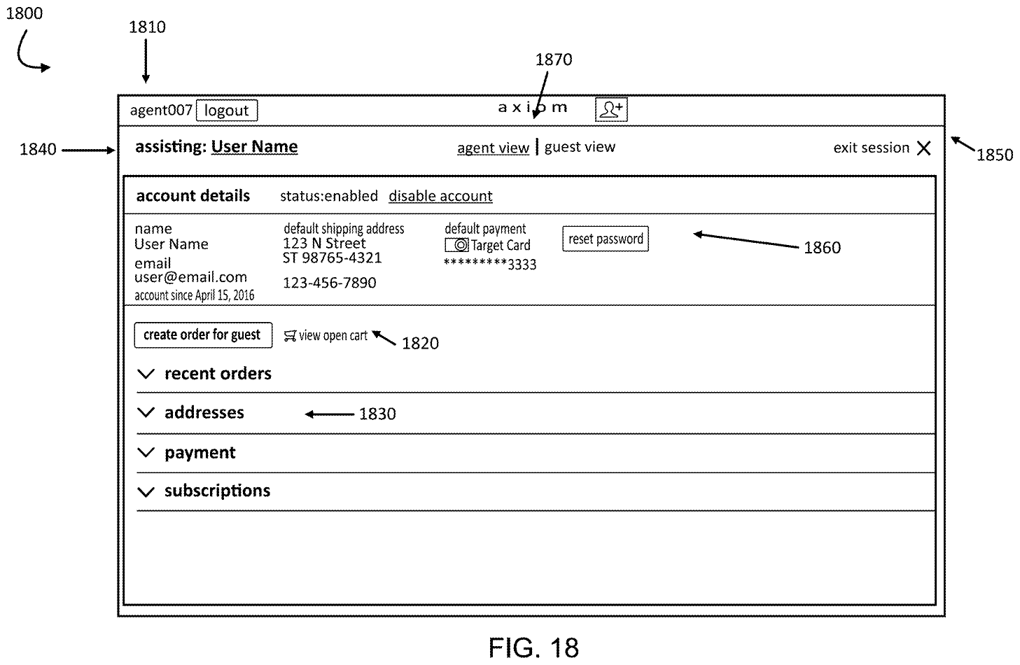

FIG. 18 illustrates an example “guest view” of the customer account, as displayed on the agent user interface 1800. The “guest view” customer account page includes some of the same features as the “agent view” customer account page, including: agent credentials 1810, active cart information 1820, order details 1830, customer name 1840, session exit button 1850 and customer details 1860.However, other features such as account summary, “Modify Cart Item Price” option 1202, “order actions” option 1608, comments/notes and recent activity summary are absent from the “guest view” as such features are only available for customer service agents as part of their roles in assisting customers. Customer service agents have the option to toggle between the “agent view” and the “guest view” using a toggle option 1670 that lists both the “agent view” and a “guest view” for the customer service agent to select from. By selecting each of the options, the customer service agent is able to quickly toggle between the two options to see if modifying a cart item price or issuing a concession for an item using the “agent view” caused the appropriate modifications in price in the “guest view” instead of relying on the customer to navigate to or refresh the active shopping cart information or the order information to verify that the modifications submitted by the customer service agent is reflected by the cart or order information on the customer user interface. The ability to toggle between the “guest view” and the “agent view” allows the customer service agents to see what the customer is seeing, thus making the process more efficient by reducing unnecessary, time consuming and sometimes confusing back and forth interactions between the customer and the customer service agent.

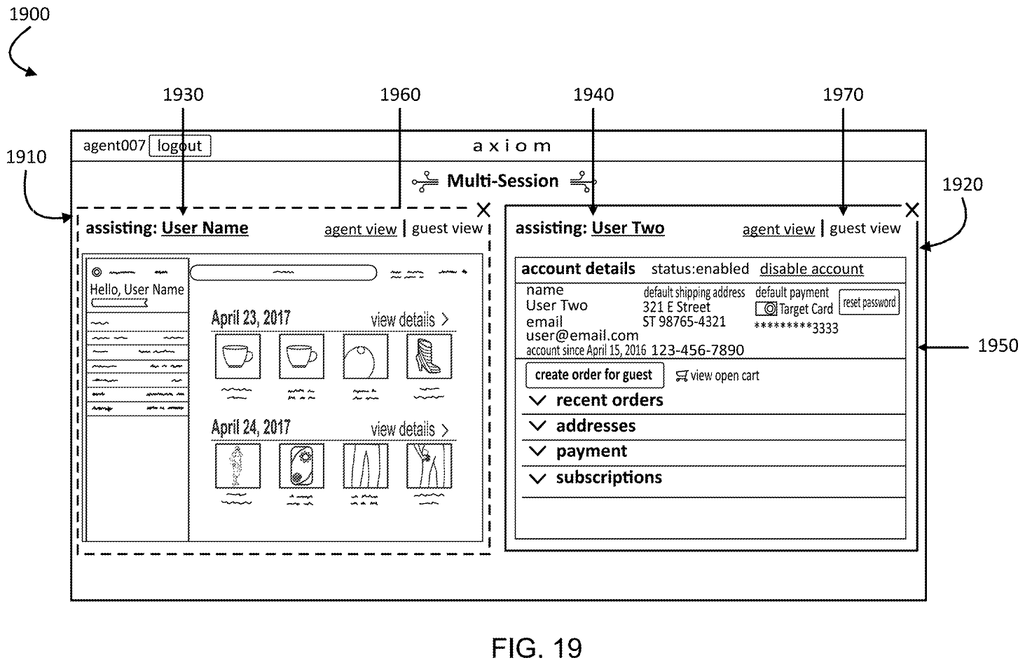

FIG. 19 illustrates the concurrent display of multiple sessions 1910, 1920 within the same agent user interface screen 1900. Each session of the multiple sessions 1910, 1920 includes a listing of the name of the customer 1930, 1940 that the customer service agent is currently helping. The session that the agent is presently actively engaging in is indicated, for example using a red outline around the session display 1950. Each session has all the same options and capabilities as discussed above. For example, each session has the toggle option 1960, 1970 to toggle between an “agent view” and a “guest view” as described in relation to FIG. 18. The multi-session feature allows for the customer service agent to be efficient and help multiple customers at the same time.

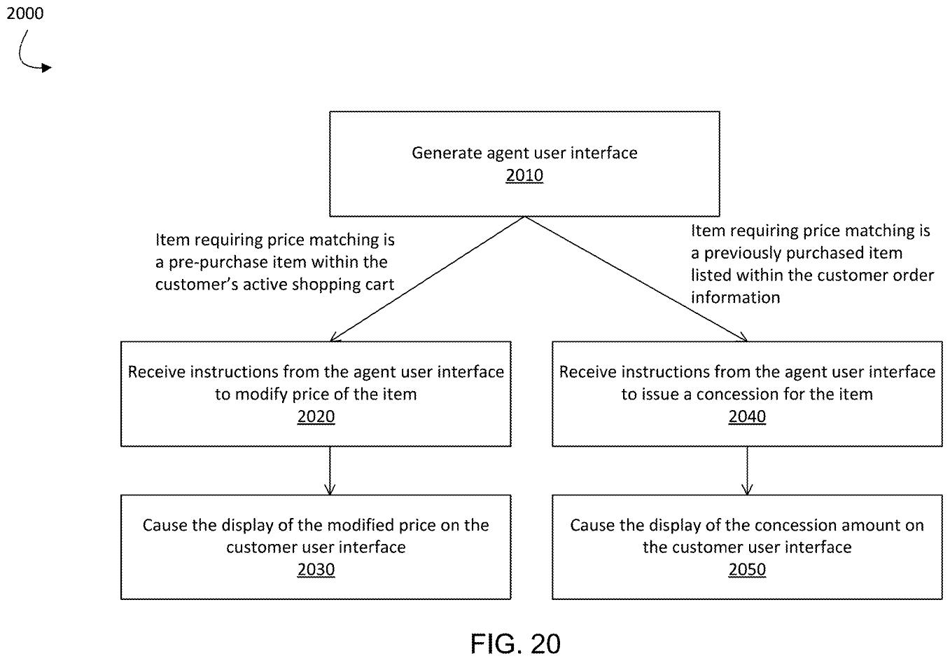

FIG. 20 illustrates a flowchart 2000 showing an example set of operations executed by the customer service assistance system 200 in price matching an item to a competitor price. The first operation 2010 from flowchart 2000 follows after performing operation 1010-1030 from FIG. 10. The flowchart 2000 is a detailed example of the operations used to perform operation 1040 of FIG. 10, where the changes to the customer's account information relates to performing a price-match for an item. Following the completion of the operations of flowchart 2000, the customer service assistance system 200 may continue to perform operation 1050 of FIG. 10.

In operation 2010, the customer service assistance system 200 generates an agent user interface and displays the agent user interface on the customer service agent device 130. For example, upon receiving a request for customer service assistance in operation 1010, the customer service agent may enter their credentials in operation 1020. Upon validating the credentials of the customer service agent and receiving customer identification information in operation 1030, the customer service assistance system 200 may generate an agent interface for display on the customer service agent device 130 that includes a graphical representation of a customer user interface as viewed by the customer on the customer device 120.

In addition to displaying a graphical representation of the customer view of the customer's account information, the agent user interface also includes one or more administrative options that are not otherwise accessible by the customer via the customer user interface. The one or more administrative options may include a first administrative option to modify the price of an item that is currently in the customer's active shopping cart, before the customer has purchased the item from the retailer. The one or more administrative options may also include a second administrative option to issue a concession for an item that the customer has already purchase from the retailer and is thus included in the customer's order information that is included within the customer's account. In addition to the first administrative option and the second administrative option, the agent user interface may also include additional administrative options to grant the customer service agent additional ways of modifying the customer account information.

The customer service agent may select the first administrative option when the customer's request in operation 1010 is for price matching an item that is still in the customer's active shopping cart and has not yet been purchased from the retailer. Upon receiving a selection of the first administrative option, the customer service assistance system 200 may execute operations 2020-2030 after operation 2010. Alternatively, the customer service agent may select the second administrative option when the customer's request in operation 1010 is for price matching an item that the customer has already purchased from the retailer. Upon receiving a selection of the second administrative option, the customer service assistance system 200 may execute operations 2040-2050 after operation 2010.

In operation 2020, the customer service assistance system 200 may receive an instruction from the agent user interface to modify the price of the item that is still in the customer's active shopping cart For example, the customer service agent may receive identification information for the item, such as an item number, a description of the item, etc. The customer service agent may then navigate through user interfaces similar to example interfaces from FIGS. 12-14 in order to identify the item within the active shopping cart, view the competitive check section 1304 in order to validate that the item qualifies for a price match to a competitor price, and submit a price modification for the item.

The customer service assistance system 200 may receive the submission for a price modification from the agent user interface and may update the shopping cart information database 510. In particular, the discount 566 and total price 568 may be updated based on the submitted price modification.

In operation 2030, the customer service assistance system 200 may cause the display of the modified price on the customer user interface. For example, the customer assistance system 200 may update the prices of items within the active shopping cart of customer user interface based on the information from the shopping cart information database 510. In doing so, the price of the item within the active shopping cart is updated to display the modified price based on the updated discount 566 and updated total price 568.

In operation 2040, the customer service assistance system 200 may receive an instruction from the agent user interface to issue a concession for the item that is in the customer order information associated with the customer's account. The customer order information may include historical list of orders that were previously purchased by the customer. For example, the customer service agent may receive identification information for the item, such as an item number, a description of the item, etc. The customer service agent may then navigate through user interfaces similar to example interfaces from FIGS. 16-17 in order to identify the item within the customer order information, view the concession competitive check section 1708 in order to validate that the item qualifies for a price match to a competitor price, and submit a concession for the item.

The customer service assistance system 200 may receive the submission for the concession for the item from the agent user interface and may update the order information database 610. In particular, any concession, which could be reimbursement, a monetary discount, a credit that can be used by the customer at the retailer, may be entered as an update to the payment information 660 or the customer's account information based on the type of concession.

In operation 2050, the customer service assistance system 200 may cause the display of the concession on the customer user interface. For example, the customer assistance system 200 may include the concession within the customer order information on the customer user interface based on the information from the order information database 610 or the customer's account information. In doing so, the customer order information and/or concession may be updated to display the concession on the on the customer user interface.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components, etc.) described with respect to the figures herein are not intended to limit the systems and methods to the particular aspects described. Accordingly, additional configurations can be used to practice the methods and systems herein and/or some aspects described can be excluded without departing from the methods and systems disclosed herein.

Similarly, where operations of a process are disclosed, those operations are described for purposes of illustrating the present methods and systems and are not intended to limit the disclosure to a particular sequence of operations. For example, the operations can be performed in differing order, two or more operations can be performed concurrently, additional operations can be performed, and disclosed operations can be excluded without departing from the present disclosure.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A system comprising:
a computing system comprising:
a processor;
a memory communicatively connected to the processor, the memory storing program instructions including a customer service tool, the program instructions being executable by the processor to cause the computing system to:
receive credential information of a customer service agent associated with a retailer;
receive identification data associated with a customer;
responsive to receiving the identification data and validating the credential information of the customer service agent, generate an agent user interface presentable at a remote customer service agent device, the agent user interface including:
a first administrative option selectable by the customer service agent to modify a price of a pre-purchase item that is included within an active shopping cart of the customer before the customer completes purchasing the pre-purchase item from the retailer, wherein upon selection of the first administrative option to modify the price of the pre-purchase item, the agent user interface displays:
a first graphical representation of the active shopping cart of the customer, the active shopping cart being associated with the identification data, and the first graphical representation having an appearance corresponding to a first customer view of the active shopping cart within a customer user interface; and
a second administrative option selectable by the customer service agent to issue a concession for an order item after the customer completes purchasing the order item from the retailer, wherein upon selection of the second administrative option to issue the concession for the order item, the agent user interface displays:
a second graphical representation of a customer order information, the customer order information being associated with the identification data, and the second graphical representation having an appearance corresponding to the second customer view of the customer order information within the customer user interface.

2. The system of claim 1, wherein the customer user interface is presented at a remote customer device.

3. The system of claim 2 wherein the program instructions further cause the computing system to:
receive an instruction to modify the price of the pre-purchase item from the active shopping cart in response to receipt of user input from the customer service agent at the user interface; and
execute the instruction, thereby modifying the price of the item, including displaying a modified price for the pre-purchase item on the first customer view of the active shopping cart within the customer user interface.

4. The system of claim 2 wherein the program instructions further cause the computing system to:
receive an instruction to issue the concession for the order item in response to receipt of user input from the customer service agent at the user interface; and
execute the instruction, thereby issuing the concession for the order item, including displaying a concession amount for the order item on the second customer view of the customer order information within the customer user interface.

5. The system of claim 1, wherein the customer service agent selecting the first administrative option to modify the price of the pre-purchase item is in response to receiving a request from the customer to match the price of the pre-purchase item to a competitor price.

6. The system of claim 1, wherein the customer service agent selecting the second administrative option to issue a concession is in response to receiving a request from the customer to match a price of the order item price to a competitor price.

7. The system of claim 1, wherein the agent user interface further displays a competitor check section that includes information retrieved from a competitor listing of the pre-purchase item or the order item, the information including one or more of:
a competitor price for the pre-purchase item or the order item;
a data at which the information was retrieved;
a time at which the information was retrieved;
a stock status for the pre-purchase item or the order item;
a name of an entity that stocks the pre-purchase item or the order item;
a name of an entity that fulfills the pre-purchase item or the order item; and
a uniform resource locator link to the competitor listing of the pre-purchase item or the order item.

8. The system of claim 7, wherein the agent user interface automatically displays a suggestion for a price modification monetary amount or a concession monetary amount, wherein:
the price modification monetary amount is a monetary amount up to which the customer service agent may modify the price of the pre-purchase item; and
the concession monetary amount is a monetary amount up to which the customer service agent may issue a concession for the order item.

9. The system of claim 8, wherein the agent user interface further includes an option for the customer service agent to manually enter a concession amount for the order item, wherein the concession amount is up to a price of the order item.

10. The system of claim 1, wherein the concession includes one or more of: a monetary discount amount, a monetary discount percentage and a credit amount to use at the retailer.

11. The system of claim 1, wherein the identification data associated with the customer include one of: a cart number, an order number, the customer email address, the customer phone number and the customer name.

12. The system of claim 1 wherein the pre-purchase item includes one or more pre-purchase items and the order item includes one or more order items.

13. A method comprising:
prompting a customer service agent to input credentials, wherein the credentials correspond to an identity of the customer service agent;
in response to a positive verification of the credentials, prompting the customer service agent to enter identification data associated with a customer;
receiving the identification data associated with the customer from the customer service agent;
in response to receiving the identification data, providing an agent user interface to the customer service agent, the agent user interface including:
a first administrative option selectable by the customer service agent to modify a price of a pre-purchase item that is included within an active shopping cart of the customer before the customer completes purchasing the pre-purchase item from the retailer, wherein upon selection of the first administrative option to modify the price of the pre-purchase item, the agent user interface displays:
a first graphical representation of the active shopping cart of the customer, the active shopping cart being associated with the identification data, and the first graphical representation having an appearance corresponding to a first customer view of the active shopping cart within a customer user interface.

14. The method of claim 13, wherein the agent user interface further includes:
a second administrative option selectable by the customer service agent to issue a concession for an order item after the customer completes purchasing the order item from the retailer, wherein upon selection of the second administrative option to issue the concession for the order item, the agent user interface displays:
a second graphical representation of a customer order information, the customer order information being associated with the identification data, and the second graphical representation having an appearance corresponding to the second customer view of the customer order information within the customer user interface.

15. The method of claim 13, wherein the customer user interface is presented at a remote customer device.

16. The method of claim 13, further comprising:
receiving an instruction to modify the price of the pre-purchase item from the active shopping cart in response to receipt of user input from the customer service agent at the user interface; and
executing the instruction, thereby modifying the price of the item, including displaying a modified price for the pre-purchase item on the first customer view of the active shopping cart within the customer user interface.

17. The method of claim 14, further comprising:
receiving an instruction to issue the concession for the order item in response to receipt of user input from the customer service agent at the user interface; and
executing the instruction, thereby issuing the concession for the order item, including displaying a concession amount for the order item on the second customer view of the customer order information within the customer user interface.

18. The method of claim 14, wherein the agent user interface further displays a competitor check section that includes information retrieved from a competitor listing of the pre-purchase item or the order item, the information including one or more of:
a competitor price for the pre-purchase item or the order item;
a data at which the information was retrieved;
a time at which the information was retrieved;
a stock status for the pre-purchase item or the order item;
a name of an entity that stocks the pre-purchase item or the order item;
a name of an entity that fulfills the pre-purchase item or the order item; and
a uniform resource locator link to the competitor listing of the pre-purchase item or the order item.

19. The method of claim 13, wherein the concession includes one or more of: a monetary discount amount, a monetary discount percentage and a credit amount to use at the retailer.

20. A system comprising:
a computing system comprising:
a processor;
a memory communicatively connected to the processor, the memory storing program instructions including a customer service tool, the program instructions being executable by the processor to cause the computing system to:
receive a request, from a customer, directed to a customer service agent representing a retailer, to match a price of an item from the retailer to a competitor price;
receive identification data associated with the customer from the customer service agent;
in response to receiving the identification data, provide an agent user interface to the customer service agent, the agent user interface including:
a graphical representation of a customer user interface as viewed by the customer on a customer device, the graphical representation including a graphical view of an active shopping cart and the customer order information associated with an account of the customer;
a first administrative option selectable by the customer service agent for when the item is a pre-purchase item that is included within the active shopping cart of the customer before the customer completes purchasing the pre-purchase item from the retailer, and
a second administrative option selectable by the customer service agent for when the item is an order item that is included within the customer order information of the customer after the customer completes purchasing the order item from the retailer; and
wherein upon selection of the first administrative option, execute instructions to modify the price of the item, a modified price for the item having a value up to the competitor price, including displaying the modified price for the item on the active shopping cart within the customer user interface as viewed by the customer on the customer device; and
wherein upon selection of the second administrative option, execute instructions to issue a concession for the item, the concession having a value that is up to the difference between the price of the item and the competitor price, including displaying the concession amount for the item on the customer order information within the customer user interface as viewed by the customer on the customer device.
